(19) United States
(12) Patent Application Publication
(10) Pub. No.: US 2026/0147384 A1
(43) Pub. Date: May 28, 2026

(54) HINGE STRUCTURE AND ELECTRONIC DEVICE COMPRISING SAME

(71) Applicant: SAMSUNG ELECTRONICS CO., LTD., Suwon-si (KR)

(72) Inventors: Changhee PARK, Suwon-si (KR); Yeonhun RYU, Suwon-si (KR); Jiho PARK, Suwon-si (KR)

(21) Appl. No.: 19/454,275

(22) Filed: Jan. 20, 2026

Related U.S. Application Data
(63) Continuation of application No. PCT/KR2024/007908, filed on Jun. 10, 2024.

(30) Foreign Application Priority Data
Jul. 20, 2023 (KR) 10-2023-0094377
Aug. 24, 2023 (KR) 10-2023-0111409

(51) Int. Cl. G06F 1/16

(52) U.S. Cl. CPC G06F 1/1681; G06F 1/1652; G06F 1/1656; G06F 1/1686

(57) ABSTRACT

An electronic device includes a first housing, a second housing, and a flexible display including an area corresponding to the first housing and an area corresponding to the second housing. A hinge assembly is at least partially disposed between the first housing and the second housing, and rotatably connects the first housing and the second housing. A hinge bracket accommodates the hinge assembly and includes a first protrusion formed to protrude in a direction opposite to the flexible display. A hinge cover is formed to cover the hinge bracket, and includes a first portion facing the first protrusion and a second portion formed to surround at least a portion of the first portion, and a sheet is disposed between the first protrusion of the hinge bracket and the first portion of the hinge cover.

### CROSS-REFERENCE TO RELATED APPLICATIONS

This application is a continuation of International Application No. PCT/KR2024/007908, filed on June 10, 2024, which is based on and claims priority to Korean Patent Application Nos. 10-2023-0094377, filed on July 20, 2023, and 10-2023-0111409, filed on August 24, 2023 in the Korean Patent Office, the disclosures of which are incorporated by reference herein in their entireties.

### BACKGROUND

Field An embodiment of the disclosure relates to a hinge structure and an electronic device including the same.

Description of Related art Advancing information communication and semiconductor technologies accelerate the spread and use of various electronic devices. In particular, recent electronic devices are being developed to carry out communication while carried on.

The term "electronic device" may mean a device performing a particular function according to its equipped program, such as a home appliance, an electronic scheduler, a portable multimedia player, a mobile communication terminal, a tablet PC, a video/sound device, a desktop PC or laptop computer, a navigation for automobile, etc. For example, the electronic devices may output stored information as voices or images. As electronic devices are highly integrated, and high-speed, high-volume wireless communication becomes commonplace, an electronic device, such as a mobile communication terminal, is recently being equipped with various functions. For example, an electronic device comes with the integrated functionality, including an entertainment function, such as playing video games, a multimedia function, such as replaying music/videos, a communication and security function, such as for mobile banking, and a scheduling or e-wallet function. These electronic devices have been downsized to be conveniently carried by users.

As mobile communication services extend up to multimedia service sectors, the display of the electronic device may be increased to allow the user satisfactory use of multimedia services as well as voice call and/or text messaging services. Accordingly, a foldable flexible display may be disposed on the entire area of the housing structure separated to be foldable.

The above-described information may be provided as related art for the purpose of helping understanding of the disclosure. No claim or determination is made as to whether any of the foregoing is applicable as background art in relation to the disclosure.

### SUMMARY

An electronic device according to an embodiment of the disclosure may comprise a first housing, a second housing, a flexible display including an area corresponding to the first housing and an area corresponding to the second housing, a hinge assembly at least partially disposed between the first housing and the second housing, and rotatably connecting the first housing and the second housing, a hinge bracket accommodating the hinge assembly and including a first protrusion formed to protrude in a direction opposite to the flexible display, a hinge cover formed to cover the hinge bracket, and including a first portion facing the first protrusion and a second portion formed to surround at least a portion of the first portion, and a sheet disposed between the first protrusion of the hinge bracket and the first portion of the hinge cover.

A hinge structure of an electronic device according to an embodiment of the disclosure may comprise a hinge assembly, a hinge bracket accommodating the hinge assembly and including a first protrusion formed to protrude in a first direction and a loop area formed to surround the first protrusion, a hinge cover including a first portion protruding in a second direction opposite to the first direction to face the first protrusion and a second portion formed to surround at least a portion of the first portion, and a sheet disposed between the first protrusion of the hinge bracket and the first portion of the hinge cover.

An electronic device according to an embodiment of the disclosure may comprise a first housing, a second housing, a flexible display disposed to include an area corresponding to the first housing and an area corresponding to the second housing, an electric component disposed in the electronic device, a bracket accommodating the electric component and including a first protrusion formed to protrude in a direction opposite to the flexible display and a loop area disposed to surround at least a portion of the first protrusion, a cover formed to cover a portion of the bracket and including a first portion facing the first protrusion and a second portion formed to surround at least a portion of the first portion, and a sheet disposed between the first protrusion of the bracket and the first portion of the cover.

### BRIEF DESCRIPTION OF DRAWINGS

FIG. 1 is a block diagram illustrating an electronic device in a network environment according to an embodiment of the disclosure;

FIG. 2 is a view illustrating an unfolded state of an electronic device according to an embodiment of the disclosure;

FIG. 3 is a view illustrating a folded state of an electronic device according to an embodiment of the disclosure;

FIG. 4 is an exploded perspective view illustrating an electronic device according to an embodiment of the disclosure;

FIG. 5 is an exploded perspective view illustrating a coupling relationship between a hinge bracket, a hinge cover, and a sheet of an electronic device according to an embodiment of the disclosure;

FIG. 6A is a view illustrating one surface of a hinge bracket facing a hinge cover of an electronic device according to an embodiment of the disclosure;

FIG. 6B is a cross-sectional view illustrating a portion of an arrangement structure between a hinge bracket and a hinge cover, taken along line A-A’ of FIG. 6A, according to an embodiment of the disclosure;

FIG. 7A is a view illustrating one surface of a hinge cover facing a hinge bracket of an electronic device according to an embodiment of the disclosure;

FIG. 7B is a cross-sectional view illustrating a portion of a structure of a hinge cover, taken along line B-B’ of FIG. 7A, according to an embodiment of the disclosure;

FIG. 8 is a see-through view illustrating a structure in which a hinge bracket and a hinge cover of an electronic device are coupled, as viewed in one direction according to embodiments of the disclosure;

FIG. 9 is a cross-sectional view illustrating a process in which a structure in which a hinge bracket and a hinge cover of an electronic device are coupled is deformed due to external impact, according to an embodiment of the disclosure;

FIG. 10 is a perspective view illustrating a hinge cover with external deformation according to an embodiment of the disclosure;

FIG. 11 is a cross-sectional view illustrating a coupling of a hinge bracket, a hinge cover, and a cover member of a hinge structure of an electronic device according to an embodiment of the disclosure;

FIG. 12 is a cross-sectional view illustrating a coupling of a hinge bracket, a hinge cover, a cover member, and a pressure sensitive member of a hinge structure of an electronic device according to an embodiment of the disclosure;

FIG. 13 is a view illustrating an inner surface of a camera cover of a structure in which the camera cover and a camera bracket of an electronic device are coupled according to an embodiment of the disclosure;

FIG. 14 is a view illustrating a camera bracket of a structure in which a camera cover and the camera bracket of an electronic device are coupled according to an embodiment of the disclosure; and

FIG. 15 is a cross-sectional view illustrating a structure in which a camera cover and a camera bracket of an electronic device are coupled according to an embodiment of the disclosure.

### DETAILED DESCRIPTION

The electronic device according to embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” "coupled to," "connected with," or “connected to” another element (e.g., a second element), it means that the element may be coupled with the other element directly (e.g., wiredly), wirelessly, or via a third element.

As used herein, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

According to embodiments, each component (e.g., a module or a program) of the above-described components may include a single entity or multiple entities. Some of the plurality of entities may be separately disposed in different components. According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

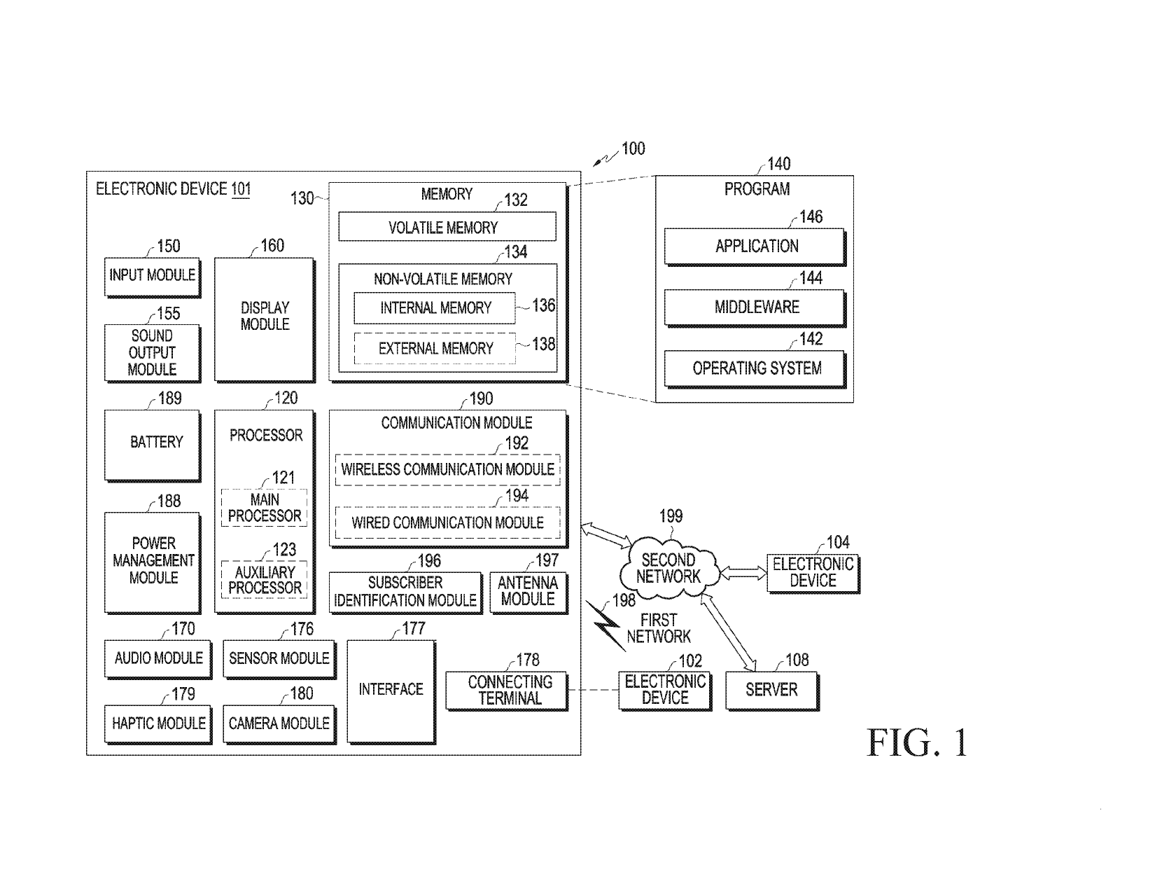

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as BluetoothTM, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client- server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

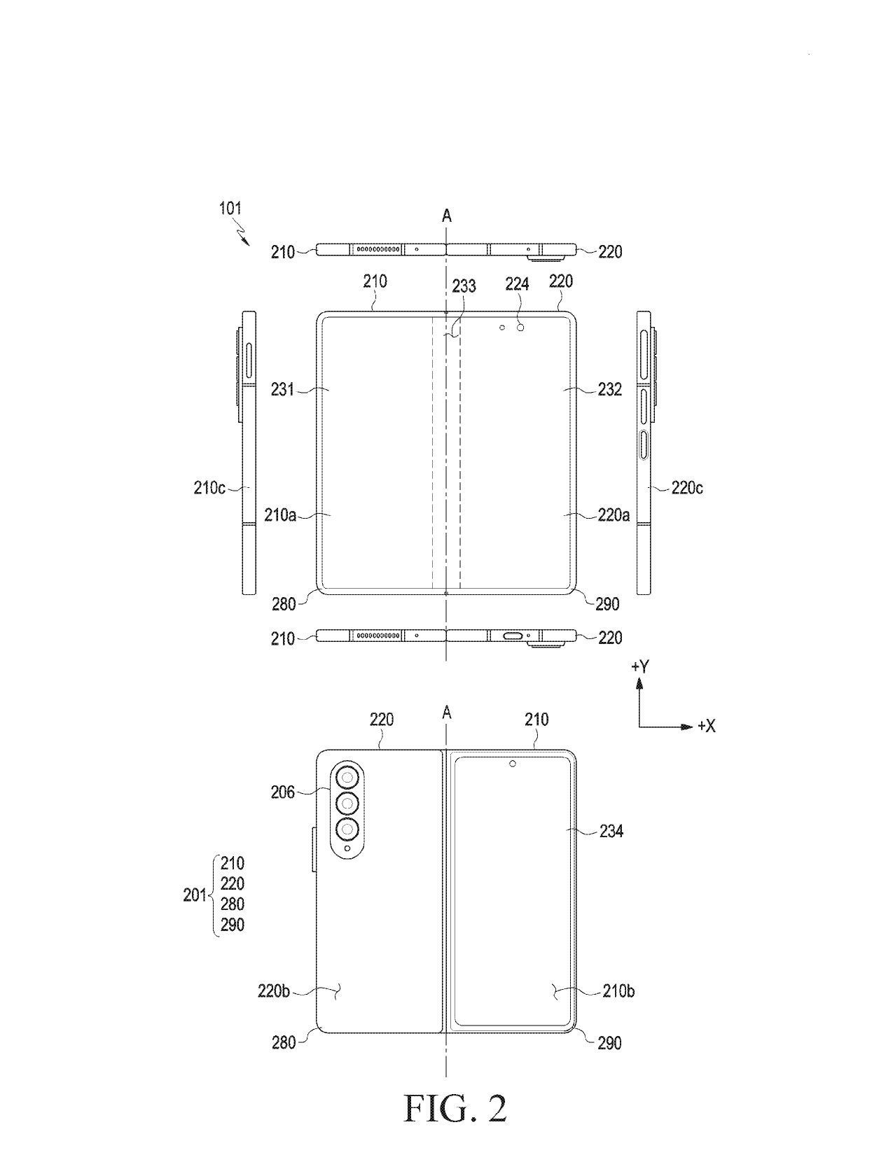

FIG. 2 is a view illustrating an unfolded state of an electronic device according to an embodiment of the disclosure.

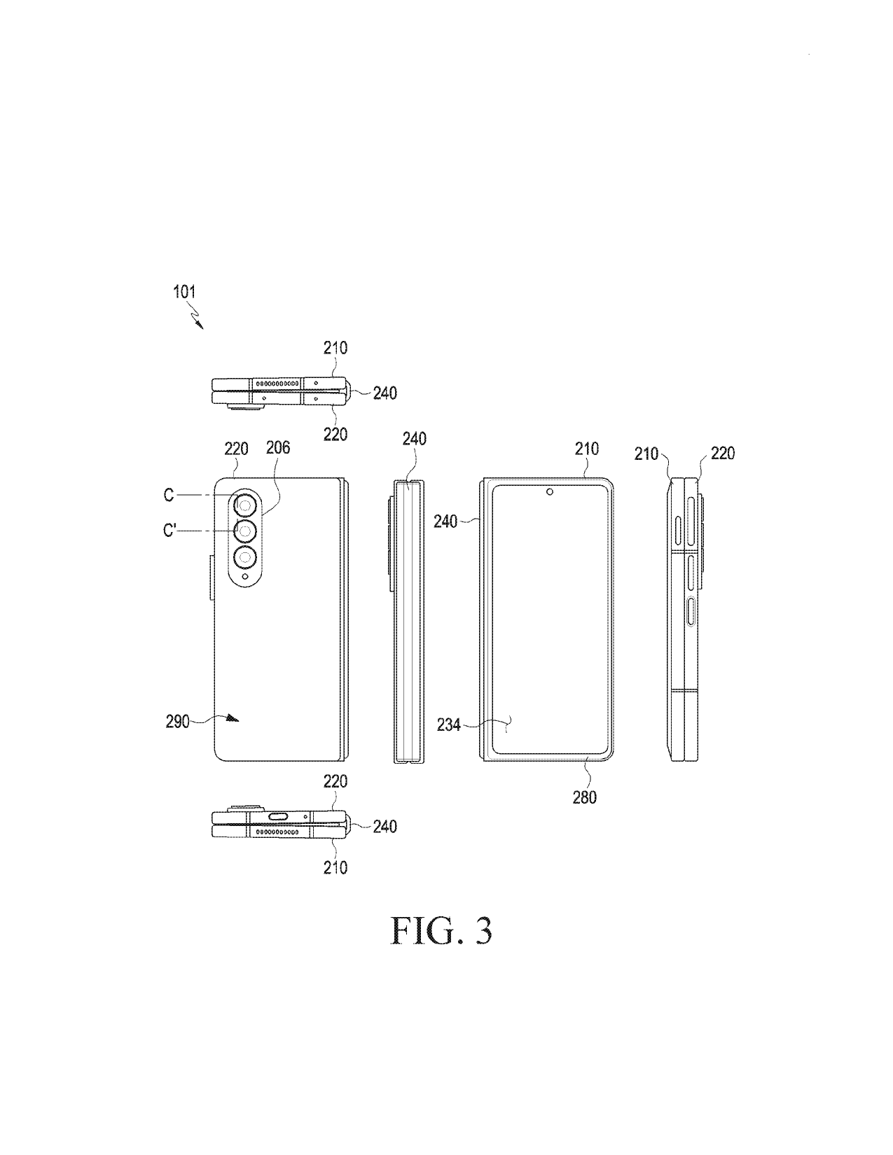

FIG. 3 is a view illustrating a folded state of an electronic device according to an embodiment of the disclosure.

Referring to FIGS. 2 and 3, an electronic device 101 may include a housing 201, a hinge cover 240 covering a foldable portion of the housing 201 (see FIG. 3), and a display 230 disposed in a space formed by the housing 201. According to an embodiment, the surface where the screen output from the display 230 is exposed is defined as a front surface (e.g., the first front surface 210a and the second front surface 220a) of the electronic device 101. A surface opposite to the front surface is defined as a rear surface (e.g., the first rear surface 210b and the second rear surface 220b) of the electronic device 101. Further, a surface surrounding the space between the front surface and the rear surface is defined as a side surface (e.g., the first side surface 210c and the second side surface 220c) of the electronic device 101. The side surface of the electronic device 101 may be a side surface of at least one of the first housing 210 or the second housing 220. The electronic device 101 of FIGS. 2 and 3 may be referred to as a foldable electronic device, a portable electronic device, or a portable foldable electronic device. According to an embodiment, the housing 201 may be referred to as a foldable housing. The display 230 may be referred to as a “flexible display.”

According to an embodiment, the housing 201 may include a first housing 210, a second housing 220 rotatable with respect to the first housing 210, a first rear cover 280, and a second rear cover 290. The housing 201 of the electronic device 101 is not limited to the shape and coupling shown in FIGS. 2 and 3 but may rather be implemented in other shapes or via a combination and/or coupling of other components. For example, in an embodiment, the first housing 210 and the first rear cover 280 may be integrally formed with each other, and the second housing 220 and the second rear cover 290 may be integrally formed with each other.

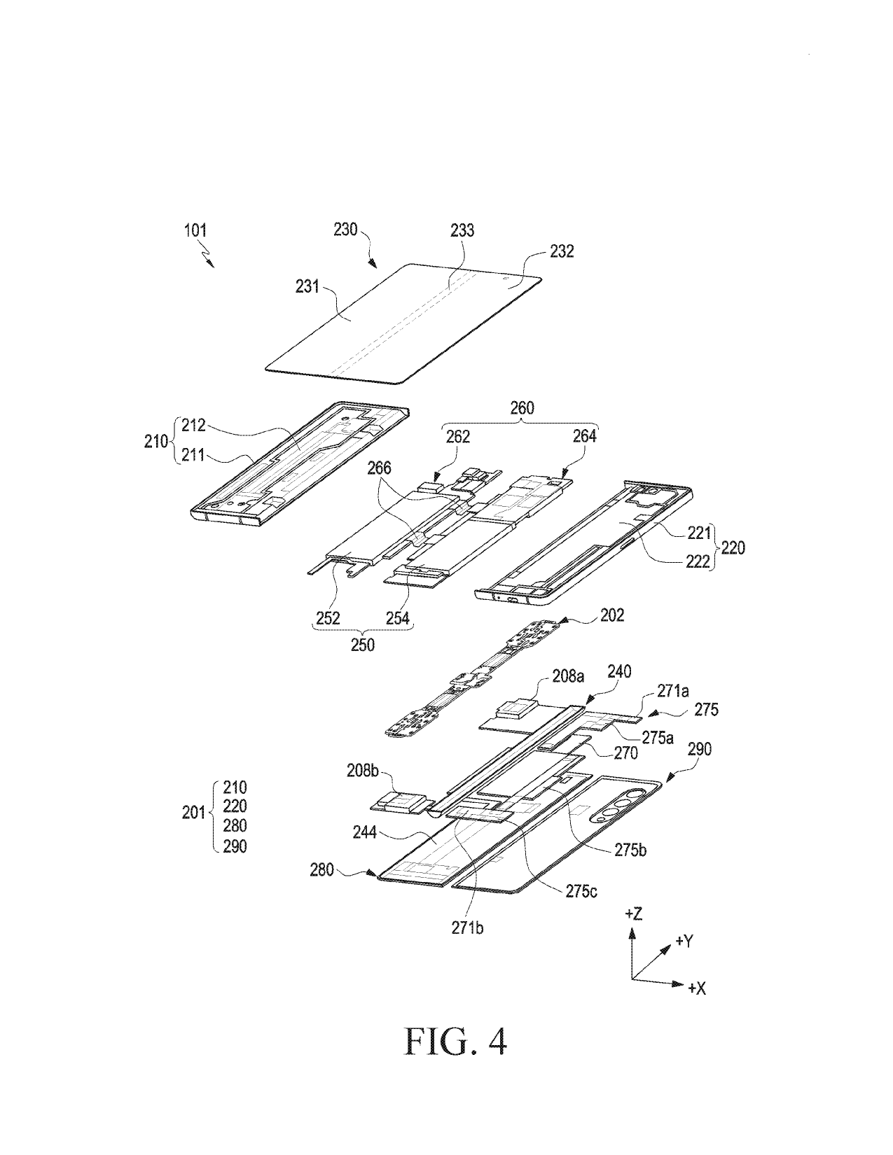

According to an embodiment, the first housing 210 may be connected to a hinge structure (e.g., the hinge assembly 202 of FIG. 4) and may include a first front surface 210a facing in a first direction and a first rear surface 210b facing in a second direction opposite to the first direction. The second housing 220 may be connected to the hinge assembly 202 and may include a second front surface 220a facing in a third direction and a second rear surface 220b facing in a fourth direction opposite to the third direction, and may rotate from the first housing 210 about the hinge assembly 202. Accordingly, the electronic device 101 may be changed to a folded state or an unfolded state. In the folded state of the electronic device 101, the first front surface 210a may face the second front surface 220a and, in the unfolded state, the third direction may be identical to the first direction. Hereinafter, unless otherwise mentioned, directions are described based on the unfolded state of the electronic device 101.

According to an embodiment, the first housing 210 and the second housing 220 are disposed on both sides of the folding axis (A) and be overall symmetrical in shape with respect to the folding axis (A). As set forth below, the first housing 210 and the second housing 220 may have different angles or distances formed therebetween depending on whether the electronic device 101 is in the unfolded, folded, or intermediate state. According to an embodiment, the second housing 220 further includes the sensor area 224 where sensors (e.g., front camera) are disposed but, in the remaining area, the second housing 220 may be symmetrical in shape with the first housing 210.

According to an embodiment, there may be provided a plurality of (e.g., two) folding axes (A) parallel to each other. In the disclosure, the folding axis (A) is provided along the length direction (Y-axis direction) of the electronic device 101, but the direction of the folding axis (A) is not limited thereto. For example (not shown), the electronic device 101 may include the folding axis (A) extending along the width direction (e.g., X-axis direction).

According to an embodiment, the electronic device 101 may include a structure to which a digital pen (not shown) may be attached. For example, the electronic device 101 may include a magnetic substance (not shown) configured to attach the digital pen to a side surface of the first housing 210 or a side surface of the second housing 220. According to an embodiment, the electronic device 101 may include a structure into which a digital pen may be inserted. For example, a hole (not shown) into which the digital pen may be inserted may be formed in a side surface of the first housing 210 or a side surface of the second housing 220 of the electronic device 101.

According to an embodiment, the first housing 210 and the second housing 220 may at least partially be formed of a metal or non-metallic material with a rigidity selected to support the display 230. At least a portion formed of metal may provide a ground plane of the electronic device 101 and may be electrically connected with a ground line formed on a printed circuit board (e.g., the circuit board 260 of FIG. 4).

According to an embodiments, the sensor area 224 may be formed adjacent to an edge or corner of the second housing 220 and to have a predetermined area. However, the placement, shape, or size of the sensor area 224 is not limited to those illustrated. For example, in another embodiment, the sensor area 224 may be provided in a different corner of the second housing 220 or in any area between the top corner and the bottom corner or in the first housing 210. In an embodiment, components for performing various functions, embedded in the electronic device 101, may be exposed through the sensor area 224 or one or more openings in the sensor area 224 to the front surface of the electronic device 101. In various embodiments, the components may include various kinds of sensors. The sensor may include, e.g., at least one of a front camera, a receiver, or a proximity sensor.

According to an embodiment, the first rear cover 280 may be disposed on one side of the folding axis A on the rear surface of the electronic device 101 and have, e.g., a substantially rectangular periphery which may be surrounded by the first housing 210. Similarly, the second rear cover 290 may be disposed on the opposite side of the folding axis A on the rear surface of the electronic device 101 and its periphery may be surrounded by the second housing 220.

According to an embodiment, the first rear cover 280 and the second rear cover 290 may be substantially symmetrical in shape with respect to the folding axis (axis A). However, the first rear cover 280 and the second rear cover 290 are not necessarily symmetrical in shape. In another embodiment, the electronic device 101 may include the first rear cover 280 and the second rear cover 290 in various shapes.

According to an embodiment, the first rear cover 280, the second rear cover 290, the first housing 210, and the second housing 220 may form a space where various components (e.g., a printed circuit board or battery) of the electronic device 101 may be disposed. According to an embodiment, one or more components may be arranged or visually exposed on/through the rear surface of the electronic device 101. For example, at least a portion of a sub display (e.g., the sub display 234 of FIG. 4) may be visually exposed through at least a portion of the first rear cover 280. In another embodiment, one or more components or sensors may be visually exposed through at least a portion of the first rear cover 290. According to various embodiments, the sensor may include a proximity sensor and/or a camera module 206 (e.g., rear camera).

According to an embodiment, a front camera exposed to the front surface of the electronic device 101 through one or more openings provided at the sensor area 224 or the camera module 206 exposed through at least a portion of the second rear cover 290 may include one or more lenses, an image sensor, and/or an image signal processor. In an embodiment, two or more lenses (an infrared (IR) camera, a wide-angle lens, and a telephoto lens) and image sensors may be disposed on one surface of the electronic device 101.

According to an embodiment, the hinge cover 240 may be disposed between the first housing 210 and the second housing 220 to hide the internal components (e.g., the hinge assembly 202 of FIG. 4). According to an embodiment, the hinge cover 240 may be hidden by a portion of the first housing 210 and second housing 220 or may be exposed to the outside depending on the state (e.g., the unfolded state (e.g., flat state) or folded state) of the electronic device 101.

According to an embodiment, as shown in FIG. 2, in the unfolded state of the electronic device 101, the hinge cover 240 may be hidden, and thus not exposed, by the first housing 210

and the second housing 220. As another example, as shown in FIG. 3, in the folded state (e.g., a fully folded state) of the electronic device 101, the hinge cover 240 may be exposed to the outside between the first housing 210 and the second housing 220. As another example, in an intermediate state in which the first housing 210 and the second housing 220 are folded with a certain angle, the hinge cover 240 may be partially exposed to the outside between the first housing 210 and the second housing 220. However, in this case, the exposed area may be smaller than that in the completely folded state. In an embodiment, the hinge cover 240 may include a curved surface.

According to an embodiment, the display 230 may be disposed in a space formed by the housing 201. For example, the display 230 may be seated on a recess formed by the housing 201 and may occupy most of the front surface of the electronic device 101. Thus, the front surface of the electronic device 101 may include the display 230 and a partial area of the first housing 210 and a partial area of the second housing 220, which are adjacent to the display 230. The rear surface of the electronic device 101 may include a first rear cover 280, a partial area of the first housing 210 adjacent to the first rear cover 280, a second rear cover 290, and a partial area of the second housing 220 adjacent to the second rear cover 290.

According to an embodiment, the display 230 may include a plurality of displays spaced apart from each other. For example, the display 230 may include a first display area 231 disposed on the first housing 210 and a second display area 232 disposed on the second housing 220. According to an embodiment, the first display area 231 and the second display area 232 may rotate about the folding axis (A).

According to an embodiment, the display 230 may mean a display at least a portion of which may be transformed into a flat or curved surface. For example, the display 230 may be a foldable or flexible display. According to an embodiment, the display 230 may include a folding area 233, a first display area 231 disposed on one side of the folding area 233 (e.g., the left side of the folding area 233 of FIG. 2), and a second display area 232 disposed on the opposite side of the folding area 233 (e.g., the right side of the folding area 203 of FIG. 2). However, the segmentation of the display 230 is merely an example, and the display 230 may be divided into a plurality of (e.g., four or more, or two) areas depending on the structure or function of the display 230. For example, in the embodiment illustrated in FIG. 2, the display 230 may be divided into the areas by the folding area 233 or folding axis (axis A) extending in parallel with the Y axis but, in another embodiment, the display 230 may be divided into the areas with respect to another folding area (e.g., a folding area parallel with the X axis) or another folding axis (e.g., a folding axis parallel with the X axis). According to an embodiment, the display 230 may be coupled with or disposed adjacent to a touch detection circuit, a pressure sensor capable of measuring the strength (pressure) of touches, and/or a digitizer (not shown) for detecting a magnetic field-type stylus pen.

According to an embodiment, the first display area 231 and the second display area 232 may be overall symmetrical in shape with respect to the folding area 233. According to an embodiment (not shown), unlike the first display area 231, the second display area 232 may include a notch depending on the presence of the sensor area 224, but the rest may be symmetrical in shape with the first display area 231. In other words, the first display area 231 and the second display area 232 may include symmetrical portions and asymmetrical portions.

Described below are the operation of the first housing 210 and the second housing 220 and each area of the display 230 depending on the state (e.g., the unfolded state (or flat state) and folded state) of the electronic device 101.

According to an embodiment, when the electronic device 101 is in the unfolded state (flat state) (e.g., FIG. 2), the first housing 210 and the second housing 220 may be disposed to face in the same direction while being angled substantially at 180 degrees therebetween. The surface of the first display area 231 and the surface of the second display area 232 of the display 230 may be angled at 180 degrees therebetween while facing in the same direction (e.g., forward of the front surface of the electronic device). The folding area 233 may form the same plane with the first display area 231 and the second display area 232.

According to an embodiment, when the electronic device 101 is in the folded state (e.g., FIG. 3), the first housing 210 and the second housing 220 may be disposed to face each other. The surface of the first display area 231 and the surface of the second display area 232 of the display 230 may be angled at a small angle (e.g., an angle between 0 degrees and 10 degrees) therefrom while facing each other. At least a portion of the folding area 233 may be formed as a curve having a predetermined curvature.

According to an embodiment, when the electronic device 101 is in the intermediate state (not shown), the first housing 210 and the second housing 220 may be disposed at a certain angle therebetween. The surface of the first display area 231 of the display 230 and the surface of the second display area 232 may form an angle which is larger than the angle in the folded state and smaller than the angle in the unfolded state. The folding area 233 may at least partially have a curved surface with a predetermined curvature and, in this case, the curvature may be smaller than that when it is in the folded state.

FIG. 4 is an exploded perspective view illustrating an electronic device according to an embodiment of the disclosure.

Referring to FIG. 4, an electronic device 101 may include a housing 201, a display 230, a hinge assembly 202, a battery 250, and a board unit 260. The housing 201 may include a first housing 210, a second housing 220, a first rear cover 280, and a second rear cover 290. The configuration of the first housing 210, the second housing 220, the hinge cover 240, the first rear cover 280, and the second rear cover 290 of FIG. 4 may be identical in whole or part to the configuration of the first housing 210, the second housing 220, the hinge cover 240, the first rear cover 280, and the second rear cover 290 of FIG. 2 and/or FIG. 3.

According to an embodiment, the first housing 210 and the second housing 220 may be assembled together to be coupled to two opposite sides of the hinge assembly 202. According to an embodiment, the first housing 210 may include a first supporting area 212 that may support the components (e.g., the first circuit board 262 and/or the first battery 252) of the electronic device 101 and a first sidewall 211 surrounding at least a portion of the first supporting area 212. The first sidewall 211 may include a first side surface (e.g., the first side surface 210c of FIG. 2) of the electronic device 101. According to an embodiment, the second housing 220 may include a second supporting area 222 that may support the components (e.g., the second circuit board 264 and/or the second battery 254) of the electronic device 101 and a second sidewall 221 surrounding at least a portion of the second supporting area 222. The second sidewall 221 may include a second side surface (e.g., the second side surface 220c of FIG. 2) of the electronic device 101.

According to an embodiment, the display 230 may include a first display area 231, a second display area 232, a folding area 233, and a sub display 234. The configuration of the first display area 231, the second display area 232, and the folding area 233 of FIG. 3 may be identical in whole or part to the configuration of the first display area 231, the second display area 232, and the folding area 233 of FIG. 1 and/or FIG. 2.

According to an embodiment, the sub display 234 may be oriented in a different direction from the display areas 231 and 232. For example, the sub display 234 may output screen in a direction opposite to the first display area 231. According to an embodiment, the sub display 234 may be disposed on the first rear cover 280.

According to an embodiment, the battery 250 may include a first battery 252 disposed in the first housing 210 and a second battery 254 disposed in the second housing 220. According to an embodiment, the first battery 252 may be connected with the first circuit board 262, and the second battery 254 may be connected to the second circuit board 264. According to an embodiment, the battery 250 may supply power to at least one component of the electronic device 101. According to an embodiment, the battery 250 may include, for example, a primary cell which is not rechargeable, a secondary cell which is rechargeable, or a fuel cell.

According to an embodiment, the board unit 260 may include a first circuit board 262 disposed in the first housing 210 and a second circuit board 264 disposed in the second housing 220. According to an embodiment, the first circuit board 262 and the second circuit board 264 may be electrically connected by at least one flexible circuit board 266. According to an embodiment, at least a portion of the flexible circuit board 266 may be disposed across the hinge assembly 202. According to an embodiment, the first circuit board 262 and the second circuit board 264 may be disposed in a space formed by the first housing 210, the second housing 220, the first rear cover 280, and the second rear cover 290. Components for implementing various functions of the electronic device 101 may be disposed on the first circuit board 262 and the second circuit board 264.

According to an embodiment, the electronic device 101 may include speakers 208a and 208b. According to an embodiment, the speakers 208a and 208b may convert the electric signal into sound. According to an embodiment, the speakers 208 and 208b may be disposed in a space formed by the first housing 210, the second housing 220, the first rear cover 280, and the second rear cover 290. According to an embodiment, the speakers 208a and 208b may include an upper speaker 208a positioned at an upper portion (+Y direction) of the electronic device 101 and a lower speaker 208b positioned at a lower portion (-Y direction) of the electronic device 101. In the disclosure, the speakers 208a and 208b are illustrated as positioned in one housing (e.g., the first housing 210 of FIG. 40, but this is an optional structure. For example, the speakers 208a and 208b may be positioned at least one of the first housing 210 or the second housing 220. The configuration of the speakers 208a and 208b of FIG. 4 may be identical in whole or part to the configuration of the sound output module 155 of FIG. 1.

According to an embodiment, the electronic device 101 may include a rear member 270 (or rear case). According to an embodiment, the rear member 270 may be disposed in the housing 201 (e.g., the second housing 220). According to an embodiment, the rear member 270 may an antenna module 275 configured to accommodate at least one antenna.

According to an embodiment, the electronic device 101 may include an antenna module 275. The antenna module 275 includes antennas 275a and 275b, which may include, e.g., an ultra-wide band (UWB) antenna 275a, a near-field communication (NFC) antenna, a wireless charging antenna, and/or a magnetic secure transmission (MST) antenna 275b. The antenna module 275 may perform short-range communication with, e.g., an external device or may wirelessly transmit or receive power necessary for charging.

According to an embodiment, an antenna structure may be formed by a portion of the housing 201 or a combination thereof. For example, the antenna module 275 may include a communication antenna 275c at least a portion of which is exposed to the outside and which forms at least a portion of the exterior of the electronic device 101. The communication antenna 275c may be used for communication (e.g., Wi-Fi) with an external electronic device. The communication antenna 275c may be connected to the upper portion 271a or the lower portion 271b of the rear member 270.

In the following detailed description, a configuration in which a pair of housings (or referred to as a ‘housing’) are coupled to be rotatable by a hinge assembly (or referred to as a ‘hinge structure’) is described as an example. However, it should be noted that the electronic device according to various embodiments of the disclosure is not limited thereto. For example, according to various embodiments, the electronic device may include three or more housings. In the embodiment disclosed below, a "pair of housings” may mean two rotatably-coupled housings among three or more housings.

A hinge structure is described below in detail.

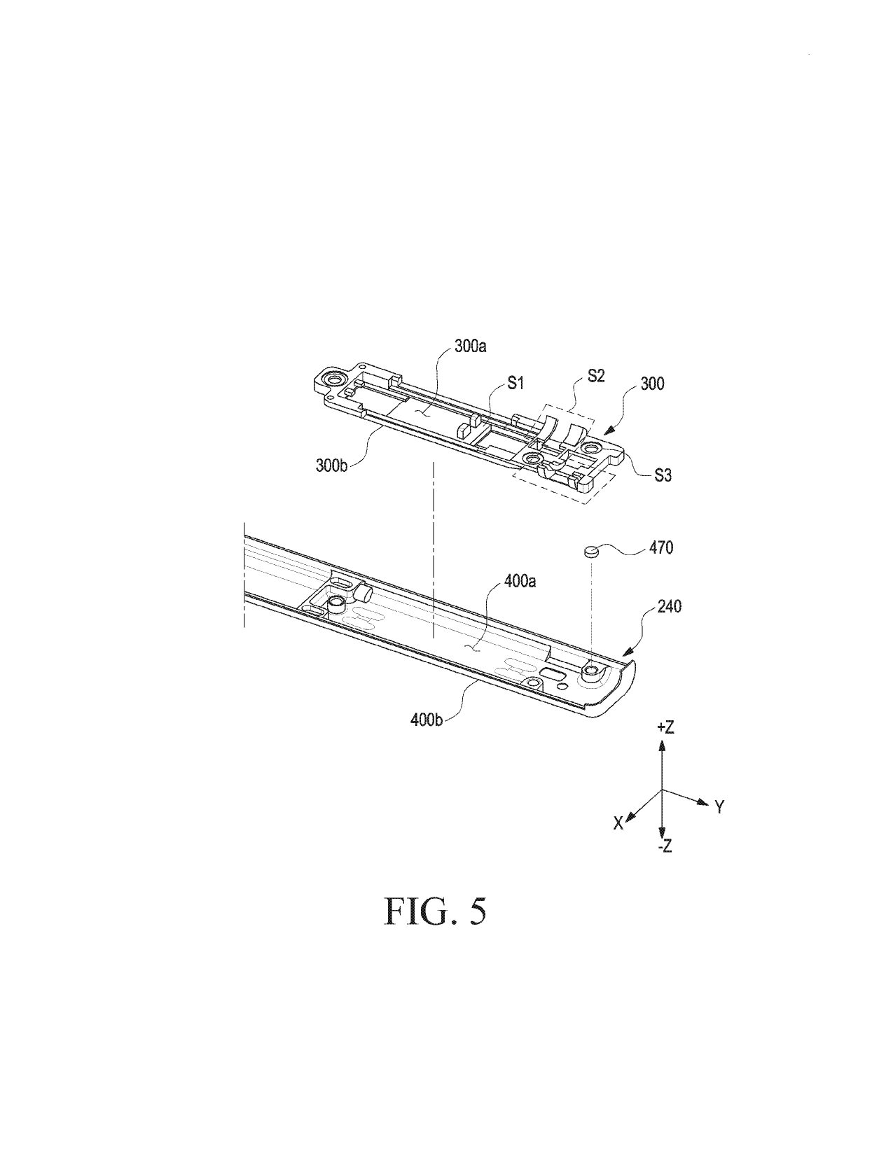

FIG. 5 is an exploded perspective view illustrating a coupling relationship between a hinge bracket, a hinge cover, and a sheet of an electronic device according to an embodiment of the disclosure.

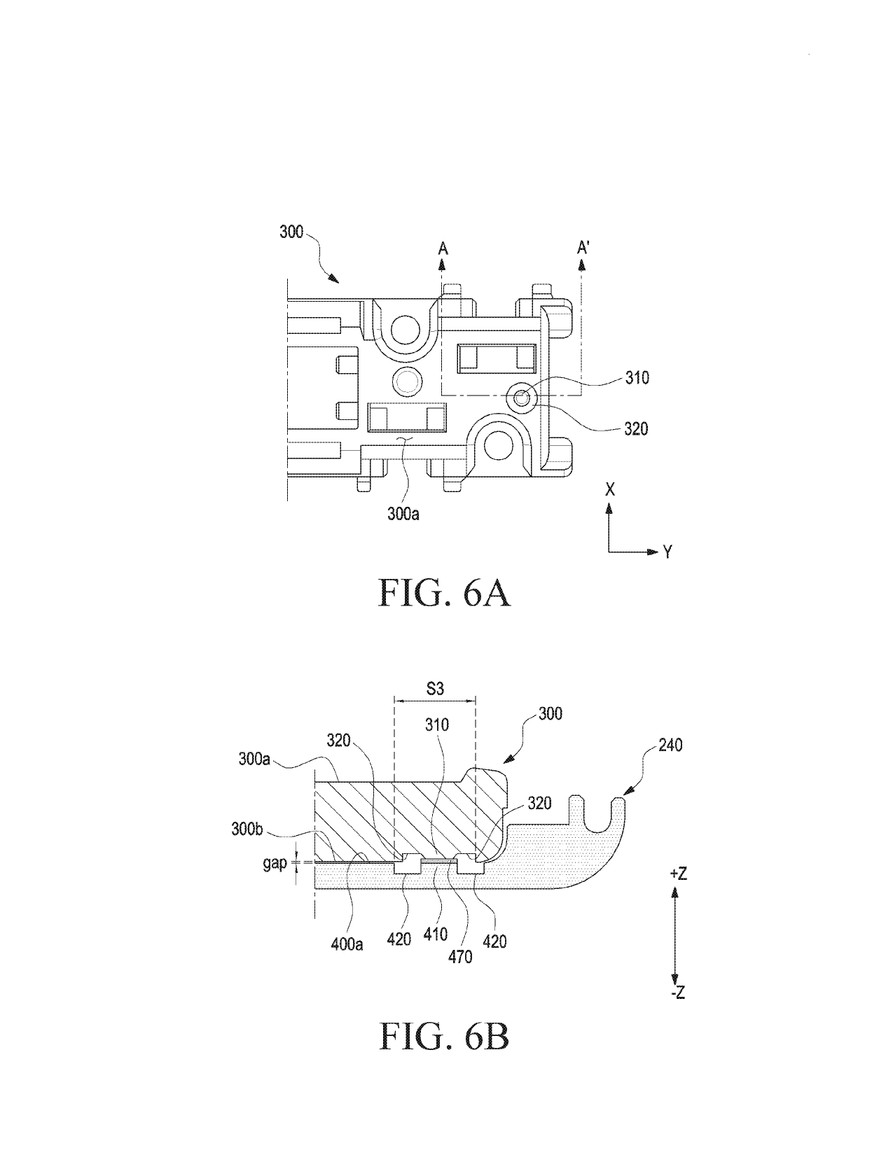

FIG. 6A is a view illustrating one surface of a hinge bracket facing a hinge cover of an electronic device according to an embodiment of the disclosure.

FIG. 6B is a cross-sectional view illustrating a portion of an arrangement structure between a hinge bracket and a hinge cover, taken along line A-A’ of FIG. 6A, according to an embodiment of the disclosure.

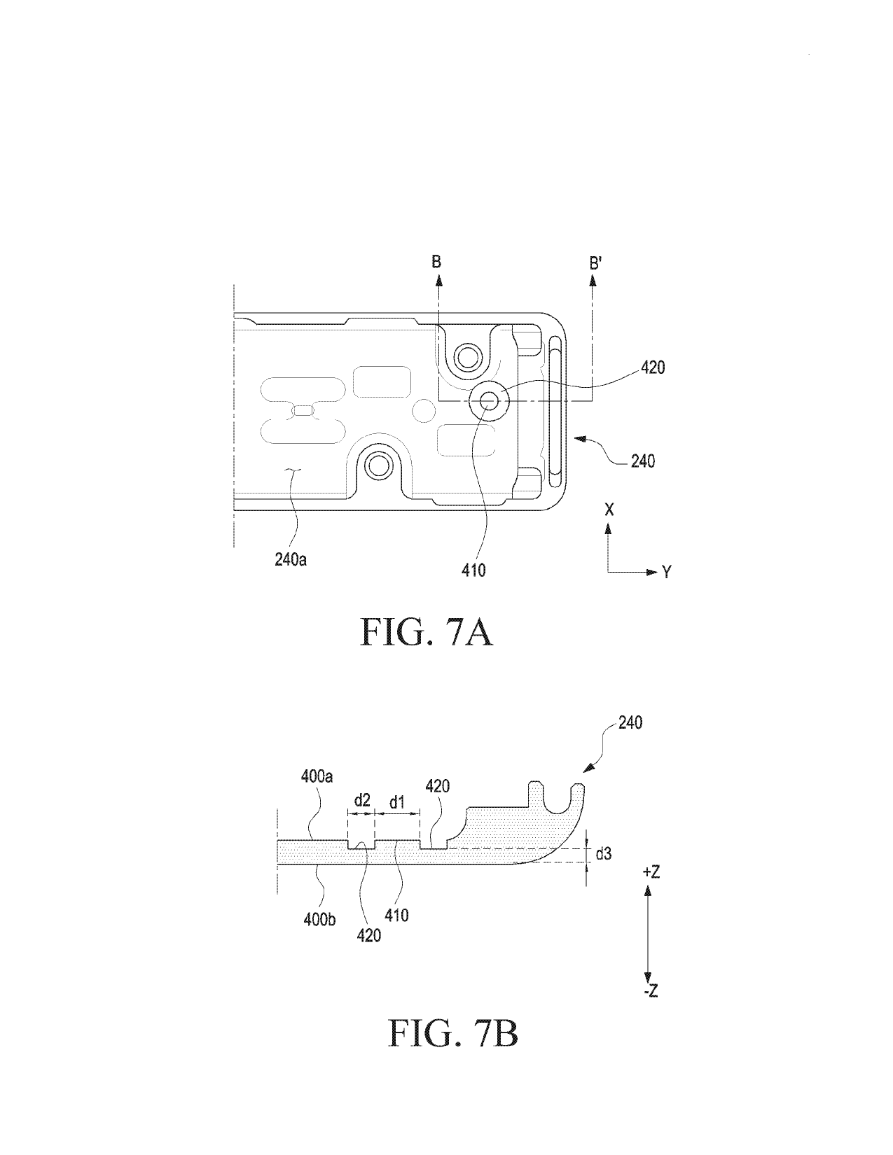

FIG. 7A is a view illustrating one surface of a hinge cover facing a hinge bracket of an electronic device according to an embodiment of the disclosure.

FIG. 7B is a cross-sectional view illustrating a portion of a structure of a hinge cover, taken along line B-B’ of FIG. 7A, according to an embodiment of the disclosure.

According to an embodiment, the electronic device (e.g., the electronic device 101 of FIG. 4) may include a first housing (e.g., the first housing 210 of FIG. 4), a second housing (e.g., the second housing 220 of FIG. 4), a flexible display (e.g., the flexible display 230 of FIG. 4) and a hinge structure (e.g., the hinge assembly 202 and the hinge cover 240 of FIG. 4) that rotatably connects the first housing and the second housing.

According to an embodiment, the hinge structure of the electronic device (e.g., the electronic device 101 of FIG. 4) may include at least one hinge (e.g., three hinges), a hinge bracket 300 on which the at least one hinge is disposed, and a hinge cover 240 covering the hinge bracket 300.

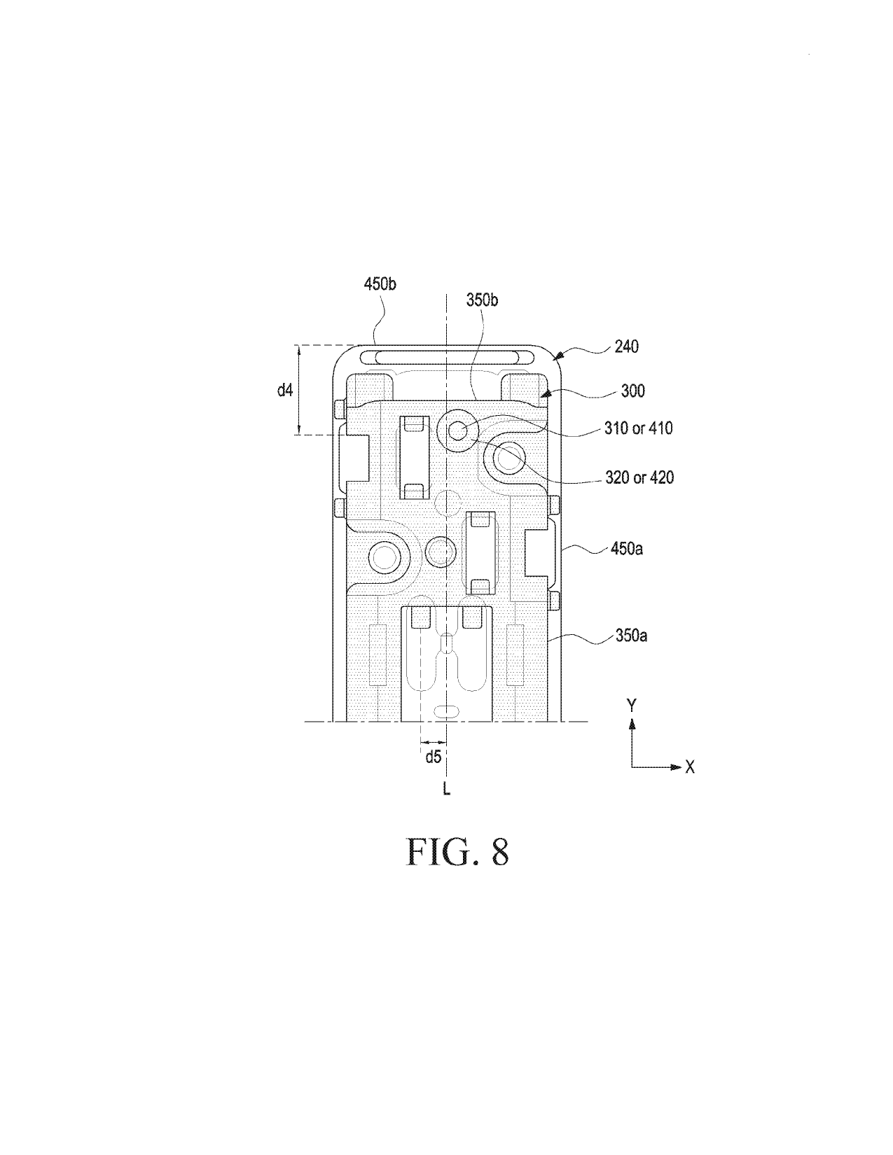

The configurations of the hinge bracket 300 and the hinge cover 240 of FIGS. 5, 6A, 6B, 7A, and 7B may be identical in whole or portion to the configuration of the hinge assembly 202 of FIG. 4 and the hinge cover 240 FIGS. 2 to 4. The embodiments of FIGS. 5, 6A, 6B, 7A, and 7B may be partially combined with the embodiments of FIGS. 1 to 4, or the embodiments of FIGS. 8 to 15.

According to an embodiment, the hinge bracket 300 may include a first area S1 accommodating a hinge, a second area S2 rotatably connected to the first housing (e.g., the first housing 210 of FIG. 4), and/or the second housing (e.g., the second housing 220 of FIG. 4), and a third area S3 having a protrusion protruding toward the hinge cover 240.

According to an embodiment, a plurality of hinge brackets 300 may be disposed between the first housing (e.g., the first housing 210 of FIG. 4) and the second housing (e.g., the second housing 220 of FIG. 4) according to the position of the hinge. For example, the hinge bracket 300 may be disposed on each of the upper and lower portions along the length direction (e.g., the Y-axis direction) of the first housing 210 and/or the second housing 220. For example, along the length direction (Y-axis direction) of the first housing 210 and/or the second housing 220, it may be disposed on an upper portion, a lower portion, and an intermediate portion (e.g., between the upper portion and the lower portion). However, the configuration of the hinge bracket 300 is not limited thereto, and various design changes may be made thereto so that a plurality of hinges are disposed within one hinge bracket 300.

According to an embodiment, the hinge bracket 300 may include a first surface 300a facing in a direction opposite to the hinge cover 240 and a second surface 300b facing the hinge cover 240. The first area S1 in which the hinge is disposed may be positioned at the first surface 300a of the hinge cover 240. A portion of the hinge may be positioned within an opening penetrating the hinge bracket 300. The second area S2 for being connected to the first and second housings 210 and 220 may be positioned at the first surface 300a of the hinge cover 240. The second area S2 may be an edge of the hinge bracket 300. At least a portion of the second area S2 may include a curved shape for smooth connection corresponding to rotation between the first and second housings 210 and 220.

According to an embodiment, the third area S3 in which the first protrusion 310 is disposed may be positioned at the second surface 300b of the hinge bracket 300. For example, the first protrusion 310 may protrude in a direction toward the hinge cover 240 (e.g., a direction toward the -Z axis). The first protrusion 310 is a portion facing the first portion 410 of the hinge cover 240, and may be formed to face or contact the first portion 410 of the hinge cover 240 so as to pressurize the first portion 410 when an external impact occurs.

According to an embodiment, the third area S3 of the hinge bracket 300 may include a first protrusion 310 and a loop area 320 disposed to surround the first protrusion 310. For example, the loop area 320 may have a shape (e.g., a valley shape) dug in the +Z axis direction compared to other areas facing the second surface 300b of the hinge bracket 300 adjacent to the loop area 320 and the first protrusion 310. The loop area 320 may have a closed loop shape disposed to completely surround the first protrusion 310 or an open loop shape disposed to partially surround the first protrusion 310.

According to an embodiment, the first protrusion 310 may have a shape protruding in the -Z-axis direction than the loop area 320. According to an embodiment, the first protrusion 310 may have a shape forming a surface having the same height in the -Z-axis direction or further protruding, as compared with the other area facing the second surface 300b of the hinge bracket 300 adjacent to the loop area 320. The loop area 320 may face and be spaced apart from at least a portion of the second portion 420 of the hinge bracket 300.

According to an embodiment, the first protrusion 310 may have a circular shape when the second surface 300b of the hinge bracket 300 is viewed in the +Z axis direction. For example, when the circular first protrusion 310 collides with the hinge cover 240 by impact, it may deform the hinge cover 240. The circular first protrusion 310 may be advantageous in deriving the deformed result of the hinge cover 240 from several angles. However, the shape of the first protrusion 310 is not limited thereto, and the design may be changed into various shapes for identifying the deformation of the hinge cover 240 from various angles.

According to an embodiment, the first protrusion 310 may have a shape of varying in size toward the -Z-axis direction. For example, the size (e.g., the circumference) of the first protrusion 310 may be sequentially (or gradually) decreased along the -Z direction. For example, the outer surface of the first protrusion 310 may form an inclined surface to have a designated slope with respect to the loop area 320 adjacent to the first protrusion 310.

According to an embodiment, the sizes of the lower side surface (e.g., the surface facing in the -Z direction) of the first protrusion 310 and the upper side surfaces (e.g., the surface facing in the +Z direction) connected to the loop area 320 may be different. The diameter of the lower side surface (e.g., the surface facing in the -Z direction) of the first protrusion 310 may be smaller than the diameter of the upper side surface (e.g., the surface facing in the +Z direction) connected to the loop area 320. The first protrusion 310 sharp in the -Z direction may provide a strong force to the hinge cover 240. According to an embodiment, the cross section of the first protrusion 310 may have a trapezoidal shape. However, the shape of the first protrusion 310 is not limited thereto, and the design may be changed into various structures for deforming the hinge cover 240 such as a cylindrical shape, a rectangular pillar shape, or a polygonal pillar shape.

According to an embodiment, the hinge cover 240 may be disposed between the first housing (e.g., the first housing 210 of FIG. 4) and the second housing (e.g., the second housing 220 of FIG. 4) to cover internal components (e.g., the hinge bracket 300 and the hinge assembly 202 of FIG. 4) so as not to be exposed to the outside. According to an embodiment, the hinge cover 240 may be covered by a portion of the first housing 210 and the second housing 220 or exposed to the outside according to the state (e.g., an unfolded state (or flat state) or a folded state) of the electronic device 101.

According to an embodiment, the hinge cover 240 may include an inner surface 400a (e.g., a surface facing the +Z axis) facing the hinge bracket 300 and an outer surface 400b facing in the opposite direction to the hinge bracket 300 (e.g., a surface facing the -Z axis). The hinge cover 240 may include a first portion 410 for providing an indicator function and a second portion 420 formed to surround at least a portion of the first portion 410.

According to an embodiment, the first portion 410 of the hinge cover 240 may be disposed to face the first protrusion 310 of the hinge bracket 300. The first portion 410 of the hinge cover 240 may be positioned on the inner surface 400a of the hinge cover 240. For example, the first portion 410 may protrude in a direction toward the hinge bracket 300 (e.g., a direction toward the +Z axis).

According to a non-limiting embodiment, the hinge cover 240 is configured to deform (e.g., realize a plastic deformation) in response to applying an external force on the hinge cover 240. When an external impact occurs, for example, the first protrusion 310 of the hinge cover 240 pressurizes the first portion 410 of the hinge cover 240, and the pressurized force is transferred to the outer surface 400b of the hinge cover 240 (e.g., the outer surface area facing the first portion 410) to deform the hinge cover 240. For example, a portion of the outer surface 400b of the hinge cover 240 may protrude.

According to an embodiment, the first protrusion 310 of the hinge bracket 300 may have a larger strength than the first portion 410 of the hinge cover 240. For example, the yield strength of the first protrusion 310 of the hinge bracket 300 may be larger than the yield strength of the first portion 410 of the hinge cover 240. For example, the yield strength of the first protrusion 310 of the hinge bracket 300 may be about 670 Megapascals (Mpa) to 800 Mpa, and the yield strength of the first portion 410 of the hinge cover 240 may be about 419 Mpa to 510 Mpa. For example, the yield strength of the first protrusion 310 of the hinge bracket 300 may be about 730 Mpa, and the yield strength of the first portion 410 of the hinge cover 240 may be about 469 Mpa. According to an embodiment, the hinge bracket 300 may has the same yield strength as the first protrusion 310 as they are formed of a single material, and the hinge cover 240 may have the same yield strength as the first portion 410 as they are formed of a single material. According to an embodiment, the hinge bracket 300 may be formed of a steel use stainless (SUS) material (e.g., SUS630), and the hinge cover 240 may be formed of a material (e.g., AL7N03) including aluminum. Since the first protrusion 310 of the hinge bracket 300 is relatively stronger than the first portion 410 of the hinge cover 240, the force applied from the hinge bracket 300 may facilitate the deformation of the hinge cover 240.

According to an embodiment, the second portion 420 of the hinge cover 240 may have a shape (e.g., a valley shape) dug in the -Z-axis direction compared to other areas of the hinge cover 240 adjacent to the second portion 420 and the first portion 410. The second portion 420 of the hinge cover 240 may be referred to as a recess, a groove, or an opening. The second portion 420 may have a closed loop shape disposed to completely surround the first portion 410 or an open loop shape disposed to partially surround the first portion 410.

According to an embodiment, the size of the second portion 420 of the hinge cover 240 may be larger than the first protrusion 310 of the hinge bracket 300. For example, when the second portion 420 and the first protrusion 310 have a circular shape, the outer diameter of the second portion 420 may be larger than the outer diameter of the first protrusion 310. For example, the outer diameter of the first protrusion 310 may be larger than the outer diameter of the first portion 410 and smaller than the outer diameter of the second portion 420.

According to an embodiment, the first portion 410 may have a shape protruding in the +Z-axis direction than the second portion 420. According to an embodiment, the first portion 410 may have a shape of forming a surface of the same height in the +Z axis direction or further protruding compared to other areas facing the inner surface 400a of the hinge cover 240 adjacent to the second portion 420.

According to an embodiment, the first portion 410 may have a shape corresponding to that of the first protrusion 310. The first portion 410 may be circular when the inner surface 400a of the hinge cover 240 is viewed in the -Z-axis direction. For example, when the circular first portion 410 deforms the outer surface 400b of the hinge cover 240 by impact, the outer surface 400b of the hinge cover 240 is also deformed into a circular shape, which may be advantageous in deriving the deformed result from various angles. However, the shape of the first portion 410 is not limited thereto, and the design may be changed into various shapes for identifying the shape of the first protrusion 310 and the deformation of the hinge cover 240 from various angles.

According to an embodiment, the size of the first portion 410 of the hinge cover 240 may be larger than the first protrusion 310 of the hinge bracket 300. For example, when the first portion 410 and the first protrusion 310 have a circular shape, the outer diameter of the first portion 410 may be larger than the outer diameter of the first protrusion 310.

According to an embodiment (e.g., see FIG. 7B), the ratio of the width (e.g., diameter d1) of the first portion 410 of the hinge cover 240 to the width of the second portion 420 surrounding the first portion 410 (e.g., the length d2 from the outside of the first portion 410 to the outside of the second portion 420) may be about 5:3 (e.g., about 12:5 to 8:7). For example, the width d1 of the first portion 410 of the hinge cover 240 may be at least 1.0 millimeter (mm) or more considering an area in which the sheet 470 is disposed. The width d2 of the second portion 420 disposed to surround the first portion 410 may have a length of about 0.6 mm or more on two opposite sides of the first portion 410. However, it may be designed in various ways considering the size and weight of the terminal.

According to an embodiment, the design of the hinge cover 240 considering deformation due to external pressure (e.g., impact) may consider the weight of the hinge cover 240 and the thickness of the hinge cover 240 according thereto. The thickness of the hinge cover 240 is a portion that may be easily deformed by external pressure, and may be defined as, e.g., the length d3 from one surface (e.g., one surface facing the +Z axis) of the second portion 420 to the outer surface 400b.

Table 1

Weight (g) of hinge cover 100 to 200 200 to 300 300 to 500

Thickness (mm) of hinge cover 0.25 or less 0.3 or less 0.35 or less

Referring to Table 1, when the weight (g) of the hinge cover 240 is about 100g or more through less than about 200g, the thickness d3 of the hinge cover 240 may be 0.25mm or less. When the weight (g) of the hinge cover 240 is about 200g or more through less than 300g (e.g., 250g), the thickness d3 of the hinge cover 240 may be 0.3mm or less. When the weight (g) of the hinge cover 240 is about 300g or more through less than about 500g, the thickness d3 of the hinge cover 240 may be 0.35mm or less.

According to an embodiment, a predetermined or more gap may be formed between the hinge bracket 300 and the hinge cover 240. For example, the peripheral area of the loop area 320 of the hinge bracket 300 and the peripheral area of the second portion 420 of the hinge cover 240 may be spaced apart from each other to form a predetermined or more gap. For example, a gap may be formed between the second surface 300b of the hinge bracket 300 and the inner surface 400a of the hinge cover 240 facing the second surface 300b. According to an embodiment, the gap may be a minimum space for forward/rearward movement (e.g., movement in the +Z-axis/-Z-axis direction) between the hinge bracket 300 and the hinge cover 240 due to an external impact. For example, the gap may be about 0.05mm or more.

According to an embodiment, the hinge structure of the electronic device (e.g., the electronic device 101 of FIG. 4) may include at least one hinge (e.g., three hinges), a hinge bracket 300 on which the at least one hinge is disposed, a hinge cover 240 covering the hinge bracket 300, and a sheet 470 disposed between the hinge bracket 300 and the hinge cover 240.

According to an embodiment, in the hinge structure, the first protrusion 310 of the hinge bracket 300 and the first portion 410 of the hinge cover 240 may be disposed in contact with each other.

According to an embodiment, the sheet 470 may be disposed between the first protrusion 310 of the hinge bracket 300 and the first portion 410 of the hinge cover 240. The sheet 470 may be referred to as a buffer member that provides a buffer function between the hinge bracket 300 and the hinge cover 240. The sheet 470 may include a flexible material. For example, the sheet 470 may include at least one of materials that provide elasticity, such as, for example, rubber, polycarbonate (PC), polyethylene terephthalate (PET), and/or foam.

According to an embodiment, the sheet 470 may be adhered to each of the first protrusion 310 and the first portion 410 to maintain an alignment between the first protrusion 310 of the hinge bracket 300 and the first portion 410 of the hinge cover 240, regardless of impact. When an impact occurs, the sheet 470 may be flexibly deformed so that the force generated by the first protrusion 310 may be sufficiently transferred to the first portion 410. The elastic force of the sheet 470 may be larger than the elastic force of the hinge bracket 300 or the hinge cover 240.

According to an embodiment, the sheet 470 may have a size (e.g., a diameter) corresponding to the first portion 410 of the hinge cover 240 and/or the first protrusion 310 of the hinge bracket 300. For example, when the first portion 410 of the hinge cover 240 has a circular shape, the sheet 470 may be a piece of circular contact paper. For example, the size (e.g., diameter) of the sheet 470 may be less than or equal to the size (e.g., diameter) of the first portion 410 of the hinge cover 240.

According to an embodiment, the hinge cover 240 may have a larger strength than the hinge bracket 300. The hinge bracket 300 may has the same yield strength as the first protrusion 310 as they are formed of a single material, and the hinge cover 240 may have the same yield strength as the first portion 410 as they are formed of a single material. For example, the yield strength of the first portion 410 of the hinge cover 240 may be larger than the yield strength of the first protrusion 310 of the hinge bracket 300. Since the first portion 410 of the hinge cover 240 is relatively stronger than the first protrusion 310 of the hinge bracket 300, the force applied from the first portion 410 of the hinge cover 240 may facilitate the deformation of the hinge bracket 300. Since the deformation of the hinge bracket 300 is not exposed by the hinge cover 240, the device may remain aesthetic regardless of the presence or absence of an external impact. Whether the hinge bracket 300 is deformed due to an external impact and/or the shape of the deformation may be identified after removing the hinge cover 240 during reassembly or repair.

FIG. 8 is a see-through view illustrating a structure in which a hinge bracket and a hinge cover of an electronic device are coupled, as viewed in one direction according to embodiments of the disclosure.

According to an embodiment, the electronic device (e.g., the electronic device 101 of FIG. 4) may include a first housing (e.g., the first housing 210 of FIG. 4), a second housing (e.g., the second housing 220 of FIG. 4), a flexible display (e.g., the flexible display 230 of FIG. 4) and a hinge structure (e.g., the hinge assembly 202 and the hinge cover 240 of FIG. 4) that rotatably connects the first housing and the second housing.

According to an embodiment, the hinge structure of the electronic device (e.g., the electronic device 101 of FIG. 4) may include at least one hinge (e.g., three hinges), a hinge bracket 300 on which the at least one hinge is disposed, and a hinge cover 240 covering the hinge bracket 300.

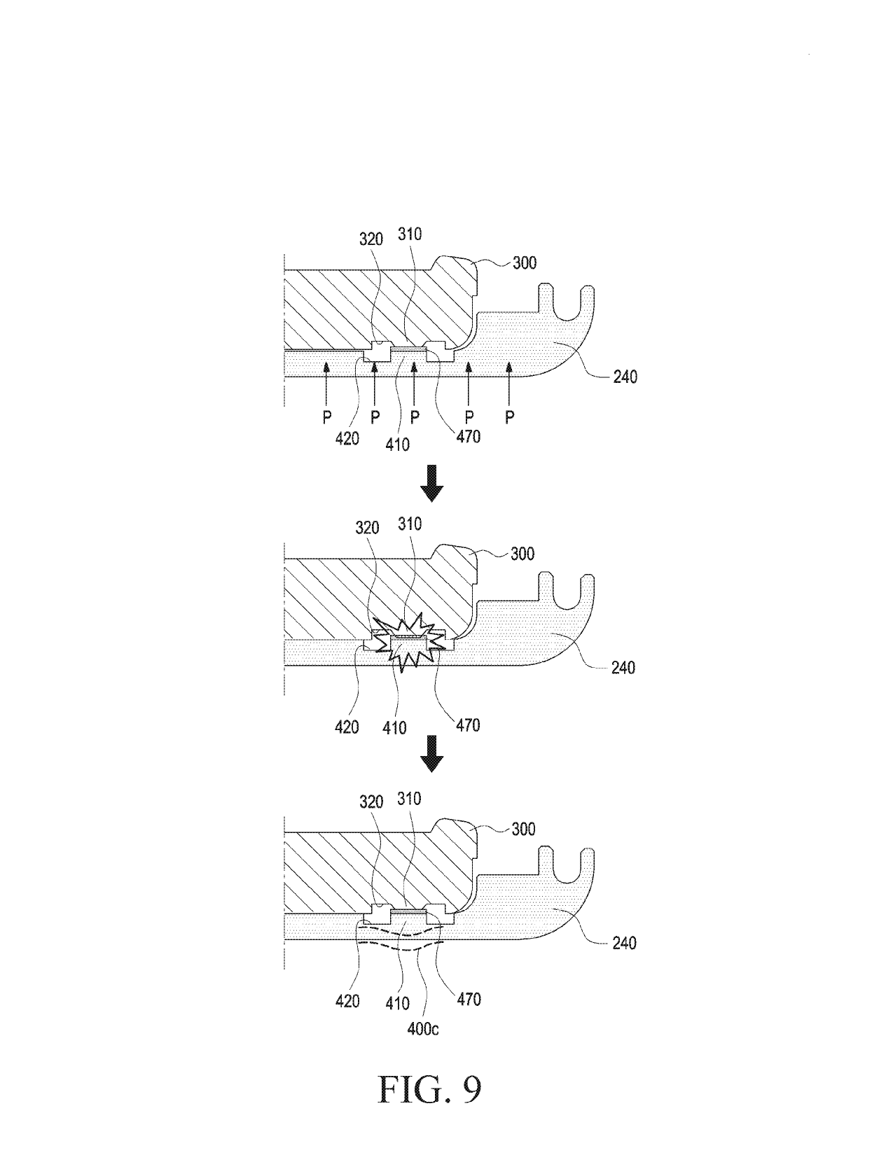

The configuration of the hinge bracket 300 and the hinge cover 240 of FIG. 8 may be identical in whole or part to the configuration of the hinge bracket 300 and the hinge cover 240 of FIGS. 5, 6A, 6B, 7A, and 7B. The embodiments of FIG. 8 may be partially combined with the embodiments of FIGS. 1 to 7B, or the embodiments of FIGS. 9 to 15.

According to an embodiment, the hinge bracket 300 may include a first protrusion 310 and a loop area 320 disposed to surround the first protrusion 310. The first protrusion 310 may have a shape protruding toward the hinge cover 240 than the loop area 320.

According to an embodiment, the hinge cover 240 may include a first portion 410 facing the first protrusion 310 and a second portion 420 formed to surround at least a portion of the first portion 410. The first portion 410 may have a shape protruding toward the hinge bracket 300 than the second portion 420.

According to an embodiment, the hinge bracket 300 may include a side edge 350a (e.g., left edge and right edge) formed along the length direction (e.g., the Y-axis direction) of the first housing (e.g., the first housing 210 of FIG. 4) and/or the second housing (e.g., the second housing 220 of FIG. 4) and an upper edge 350b and a lower edge formed along a direction (e.g., the X-axis direction) perpendicular to the side edge. The side edge 350a (e.g., left edge and right edge) may be defined as a long side edge longer than the upper edge 350b (and/or lower edge).

According to an embodiment, the first protrusion 310 of the hinge bracket 300 may be disposed adjacent to the upper edge 350b or the lower edge of the hinge bracket 300. According to an embodiment, when there are a plurality of hinge brackets 300 which overlap the upper and lower sides of the hinge cover 240, the first protrusion 310 of one hinge bracket 300 may be disposed at the upper edge 350b of the hinge bracket 300, and the first protrusion 310 of another hinge bracket 300 may be disposed adjacent to the lower edge of the hinge bracket 300.

According to an embodiment, when viewing the outer surface of the hinge bracket 300 and/or the hinge cover 240 (e.g., when the hinge cover 240 is viewed from the outside in the -Z direction), the first protrusion 310 of the hinge bracket 300 may be disposed at or adjacent to the center of the hinge bracket 300 (e.g., the hinge cover 240) with respect to the upper edge 350b of the hinge bracket 300 (or hinge cover 240) (e.g., with respect to the width direction (X-axis direction)).

According to an embodiment, the hinge cover 240 may include a side edge 450a (e.g., left edge and right edge) formed along the length direction (e.g., the Y-axis direction) of the first housing (e.g., the first housing 210 of FIG. 4) and/or the second housing (e.g., the second housing 220 of FIG. 4) and an upper edge 450b and a lower edge formed along a direction (e.g., the X-axis direction) perpendicular to the side edge. The side edge 450a (e.g., left edge and right edge) may be defined as a long side edge longer than the upper edge 450b (and/or lower edge).

According to an embodiment, the first portion 410 (or the first protrusion 310) of the hinge cover 240 may be disposed adjacent to the upper edge 450b or the lower edge of the hinge cover 240. According to an embodiment, when there are a plurality of hinge brackets 300 which overlap the upper and lower sides of the hinge cover 240, the first portion 410 facing the first protrusion 310 of the upper edge 350b of the hinge bracket 300 may be disposed adjacent to the upper edge 450b of the hinge cover 240, and the first portion 410 facing the first protrusion 310 of the lower edge of the hinge bracket 300 may be disposed adjacent to the lower edge of the hinge cover 240.

According to an embodiment, when viewing the outer surface of the hinge cover 240 (e.g., when the hinge cover 240 is viewed from the outside in the -Z direction), the first portion 410 (or the first protrusion 310) of the hinge cover 240 may be disposed at or adjacent to the center of the hinge cover 240 with respect to the upper edge 450b of the hinge cover 240 (e.g., with respect to the width direction (X-axis direction)).

According to an embodiment, the first portion 410 of the hinge cover 240 and the first protrusion 310 of the hinge bracket 300 may be positioned within a predetermined distance d4 from the upper edge 450b of the hinge cover 240. For example, the first portion 410 of the hinge cover 240 and the first protrusion 310 of the hinge bracket 300 may be positioned about 5mm or less from the upper edge 450b of the hinge cover 240.

According to an embodiment, the first portion 410 of the hinge cover 240 and the first protrusion 310 of the hinge bracket 300 may be positioned within a predetermined distance d5 from, the center L of the hinge cover 240 with respect to the upper edge 450b of the hinge cover 240 (e.g., with respect to the width direction (X-axis direction)). For example, the first portion 410 of the hinge cover 240 and the first protrusion 310 of the hinge bracket 300 may be positioned within about 1mm or less to the left/right from, the center L of the hinge cover 240 with respect to the upper edge 450b of the hinge cover 240 (e.g., with respect to the width direction (X-axis direction)).

When the hinge structure is damaged and partially deformed by an impact such as a drop, the upper edge 450b or 350b (and/or lower edge) of the hinge cover 240 or hinge bracket 300 is more likely to collide with the floor (e.g., the ground). As the first protrusion 310 of the hinge bracket 300 is disposed adjacent to the upper edge 350b (and/or lower edge) of the hinge bracket 300, or the first portion 410 of the hinge cover 240 is disposed adjacent to the upper edge 450b (and/or lower edge) of the hinge cover 240, impact caused by collision may be easily absorbed and transferred.

Further, if the hinge structure is damaged and partially deformed by an impact such as a drop, the center (or an area adjacent to the center) with respect to the upper edge 450b or 350b of the hinge cover 240 or the hinge bracket 300 is more likely to collide with a floor (e.g., the ground) as the hinge cover 240 has a curved shape which is convex toward the outside. As the first protrusion 310 of the hinge bracket 300 is disposed adjacent to the center L (or area adjacent to the center) of the hinge bracket 300, or the first portion 410 of the hinge cover 240 is disposed adjacent to the center L (or area adjacent to the center) of the hinge cover 240, it is possible to easily absorb and transfer impact caused by collision.

FIG. 9 is a cross-sectional view illustrating a process in which a structure in which a hinge bracket and a hinge cover of an electronic device are coupled is deformed due to external impact, according to an embodiment of the disclosure.

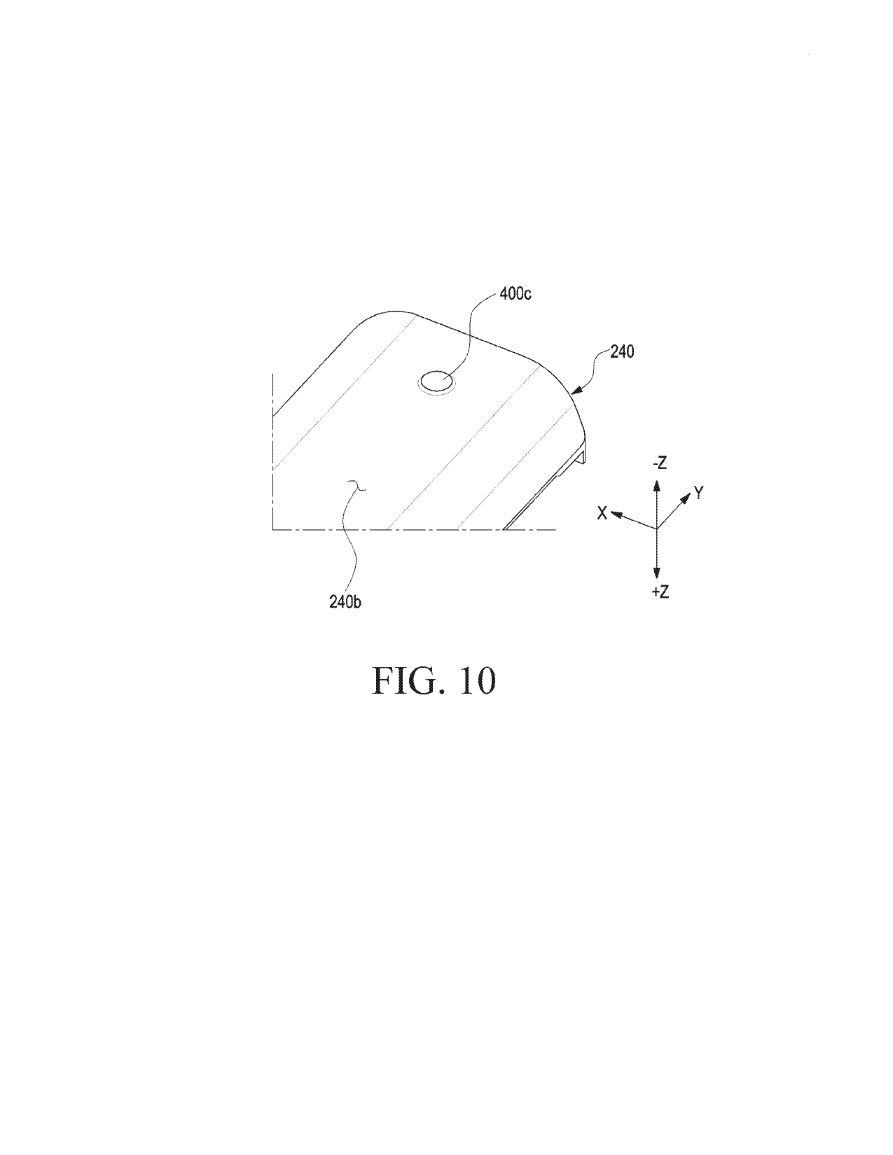

FIG. 10 is a perspective view illustrating a hinge cover with external deformation according to an embodiment of the disclosure.

According to an embodiment, the electronic device (e.g., the electronic device 101 of FIG. 4) may include a first housing (e.g., the first housing 210 of FIG. 4), a second housing (e.g., the second housing 220 of FIG. 4), a flexible display (e.g., the flexible display 230 of FIG. 4) and a hinge structure (e.g., the hinge assembly 202 and the hinge cover 240 of FIG. 4) that rotatably connects the first housing and the second housing.

According to an embodiment, the hinge structure of the electronic device (e.g., the electronic device 101 of FIG. 4) may include at least one hinge (e.g., three hinges), a hinge bracket 300 on which the at least one hinge is disposed, and a hinge cover 240 covering the hinge bracket 300.

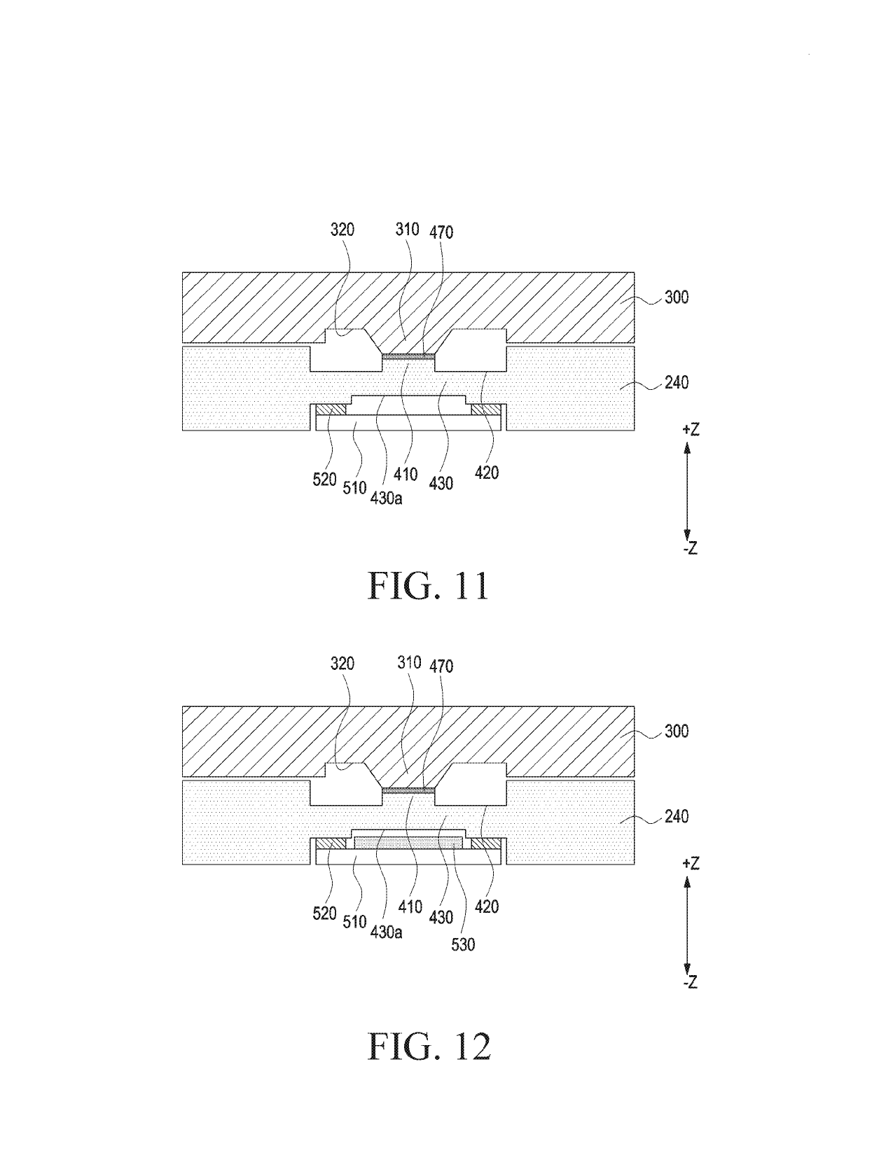

The configuration of the hinge bracket 300 and the hinge cover 240 of FIGS. 9 and 10 may be identical in whole or part to the configuration of the hinge bracket 300 and the hinge cover 240 of FIGS. 5, 6A, 6B, 7A, 7B, and 8. The embodiments of FIGS. 9 and 10 may be partially combined with the embodiments of FIGS. 1 to 8, or the embodiments of FIGS. 11 to 15.

According to an embodiment, the hinge bracket 300 may include a first protrusion 310 and a loop area 320 disposed to surround the first protrusion 310. The first protrusion 310 may have a shape protruding toward the hinge cover 240 (e.g., in the -Z-axis direction) than the loop area 320.

According to an embodiment, the hinge cover 240 may include a first portion 410 facing the first protrusion 310 and a second portion 420 formed to surround at least a portion of the first portion 410. The first portion 410 may have a shape protruding toward the hinge bracket 300 (e.g., the +Z-axis direction) than the second portion 420.

Referring to FIG. 9(a), when the hinge structure of the electronic device receives an external impact (P), the direction of the impact may be the +Z-axis direction. For example, if the electronic device falls and the outer surface of the hinge cover 240 collides with the floor e.g., the ground, an impact (P) may be applied to the outer surface of the hinge cover 240.

Referring to FIG. 9(b), when an impact generated on the hinge cover 240 is an external force equal to or larger than a predetermined magnitude, the first portion 410 of the hinge cover 240 and the first protrusion 310 of the hinge bracket 300 may collide with each other. The hinge cover 240 may be overall pushed in the +Z-axis direction, and the force may be concentrated onto the first portion 410 of the hinge cover 240 and the first protrusion 310 of the hinge bracket 300, which protrude while facing each other. As the yield strength of the hinge bracket 300 is relatively larger than the yield strength of the hinge cover 240, the first protrusion 310 of the hinge bracket 300 may pressurize the first portion 410 of the hinge cover 240, and a portion of the hinge cover 240 may be deformed.

Referring to FIG. 9(c) and FIG. 10, the first protrusion 310 of the hinge bracket 300 pressurizes the first portion 410 of the hinge cover 240, and the first portion 410 of the hinge cover 240 is pushed in the -Z axis direction, forming a protruding portion 400c on the outer surface 400b of the hinge cover 240. The protruding portion 400c formed on the outer surface 400b of the hinge cover 240 may have a shape corresponding to the first portion 410 of the hinge cover 240. For example, the protruding portion 400c may have a circular shape when the first portion 410 of the hinge cover 240 is a circular protrusion. A predetermined portion of the circular protruding portion 400c may protrude more or less according to the direction and position of the impact.

FIG. 11 is a cross-sectional view illustrating a coupling of a hinge bracket, a hinge cover, and a cover member of a hinge structure of an electronic device according to an embodiment of the disclosure.

FIG. 12 is a cross-sectional view illustrating a coupling of a hinge bracket, a hinge cover, a cover member, and a pressure sensitive member of a hinge structure of an electronic device according to an embodiment of the disclosure.

According to an embodiment, the electronic device (e.g., the electronic device 101 of FIG. 4) may include a first housing (e.g., the first housing 210 of FIG. 4), a second housing (e.g., the second housing 220 of FIG. 4), a flexible display (e.g., the flexible display 230 of FIG. 4) and a hinge structure (e.g., the hinge assembly 202 and the hinge cover 240 of FIG. 4) that rotatably connects the first housing and the second housing.

According to an embodiment, the hinge structure of the electronic device (e.g., the electronic device 101 of FIG. 4) may include at least one hinge, a hinge bracket 300 on which the at least one hinge is disposed, and a hinge cover 240 covering the hinge bracket 300.

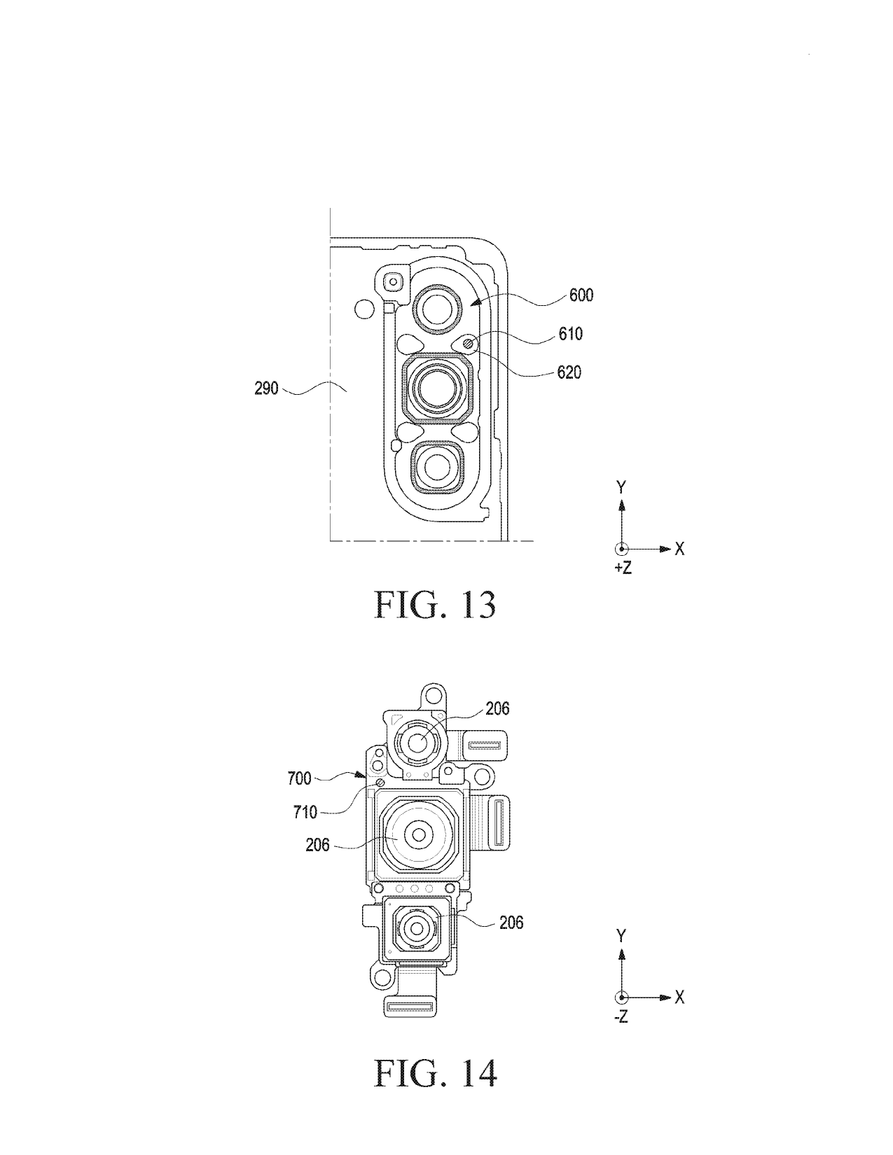

The configuration of the hinge bracket 300 and the hinge cover 240 of FIGS. 11 and 12 may be identical in whole or part to the configuration of the hinge bracket 300 and the hinge cover 240 of FIGS. 5, 6A, 6B, 7A, 7B, 8, 9, and 10. The embodiments of FIGS. 11 and 12 may be partially combined with the embodiments of FIGS. 1 to 10, or the embodiments of FIGS. 13 to 15.

Referring to FIGS. 11 and 12, the hinge structure may include a hinge bracket 300, a hinge cover 240, and a cover member 510 covering a portion of the hinge cover 240 not to be exposed.

According to an embodiment, the hinge bracket 300 may include a first protrusion 310 and a loop area 320 disposed to surround the first protrusion 310. The first protrusion 310 may have a shape protruding toward the hinge cover 240 (e.g., in the -Z-axis direction) than the loop area 320.

According to an embodiment, the hinge cover 240 may include a first portion 410 facing the first protrusion 310 and a second portion 420 formed to surround at least a portion of the first portion 410. The first portion 410 may have a shape protruding toward the hinge bracket 300 (e.g., the +Z-axis direction) than the second portion 420.

According to an embodiment, the sheet 470 may be disposed between the first protrusion 310 of the hinge bracket 300 and the first portion 410 of the hinge cover 240.

According to an embodiment, the hinge cover 240 may include a first portion 410 and a deformable portion 430 in which the second portion 420 is formed, and the deformable portion 430 may include a surface facing the +Z axis and a surface facing the -Z axis. The surface facing the +Z axis may include a first portion 410 and a second portion 420, and the surface facing the -Z axis may be a recessed area 430a compared to a peripheral area. The recessed area 430a of the deformable portion 430 may have a shape dug along the +Z-axis direction.

According to an embodiment, the cover member 510 may be disposed within a space formed by the recessed area 430a of the hinge cover 240. When the hinge structure is externally impacted, the outer surface of the hinge cover 240 (e.g., a surface facing in the opposite direction to the first portion 410) may be varied to protrude in the -Z-axis direction. The cover member 510 may cover the deformable portion 430 so that the variable portion (e.g., the deformable portion 430) of the hinge cover 240 is not exposed to the outside. For example, the surface of the cover member 510 facing the +Z axis may be disposed to face the deformable portion 430, and the surface facing the -Z axis may be disposed to be exposed to the outside.

According to an embodiment, the cover member 510 disposed facing the recessed area 430a of the hinge cover 240 may be disposed to form a predetermined gap considering the variation of the deformable portion 430. For example, a gap may be formed between the cover member 510 and the surface facing in the direction opposite to the first portion 410. According to an embodiment, the cover member 510 may be formed in a sheet type to be advantageous for later removal and assembly.

According to an embodiment, the surface of the cover member 510 facing the -Z axis may be formed of the same color or material so as not to be distinguished from the surrounding hinge cover 240. The surface facing the -Z axis of the cover member 510 may be seamlessly connected to the peripheral hinge cover 240 portion. When the peripheral hinge cover 240 portion is a curved surface, the surface of the cover member 510 facing the -Z axis may form a curved surface having the same curvature.

According to an embodiment, the hinge structure may include an adhesive member 520 for the cover member 510 to adhere to the recessed area 430a of the hinge cover 240. The adhesive member 520 may be disposed at an edge of the cover member 510 considering the variation of the deformable portion 430. The adhesive member 520 may be formed of a tape or by bonding.

According to an embodiment, as the outer surface generated by the impact of the hinge cover 240 is not exposed to the outside, the electronic device may remain aesthetic. When the cover member 510 is removed during removal and assembly for repair, it is possible to identify the protruding portion of the deformable portion 430 to identify whether it is damaged and/or the cause for the damage (e.g., drop or intentional dent).

Referring to FIG. 12, the hinge structure may include a pressure sensitive member 530 disposed between the deformable portion 430 of the hinge cover 240 and the cover member 510. The pressure sensitive member 530 may be advantageous in identifying a variation of the deformable portion 430. The pressure sensitive member 530 is a member formed to sense pressure, and may have a sheet-type shape (e.g., carbonless duplication paper).

According to an embodiment, the cover member 510 and the pressure sensitive member 530 disposed at the recessed area 430a of the hinge cover 240 may be disposed to form a predetermined gap considering the variation of the deformable portion 430. For example, a gap may be formed between the pressure sensitive member 530 and the surface facing in the direction opposite to the first portion 410.

According to an embodiment, as the outer surface generated by the impact of the hinge cover 240 is not exposed to the outside, the electronic device may remain aesthetic. When the cover member 510 is removed during removal and assembly for repair, it is possible to identify the protruding portion of the deformable portion 430 and the portion marked on the pressure sensitive member 530 to identify whether it is damaged and/or the cause for the damage (e.g., drop or intentional dent).

FIG. 13 is a view illustrating an inner surface of a camera cover of a structure in which the camera cover and a camera bracket of an electronic device are coupled according to an embodiment of the disclosure.

FIG. 14 is a view illustrating a camera bracket of a structure in which a camera cover and the camera bracket of an electronic device are coupled according to an embodiment of the disclosure.

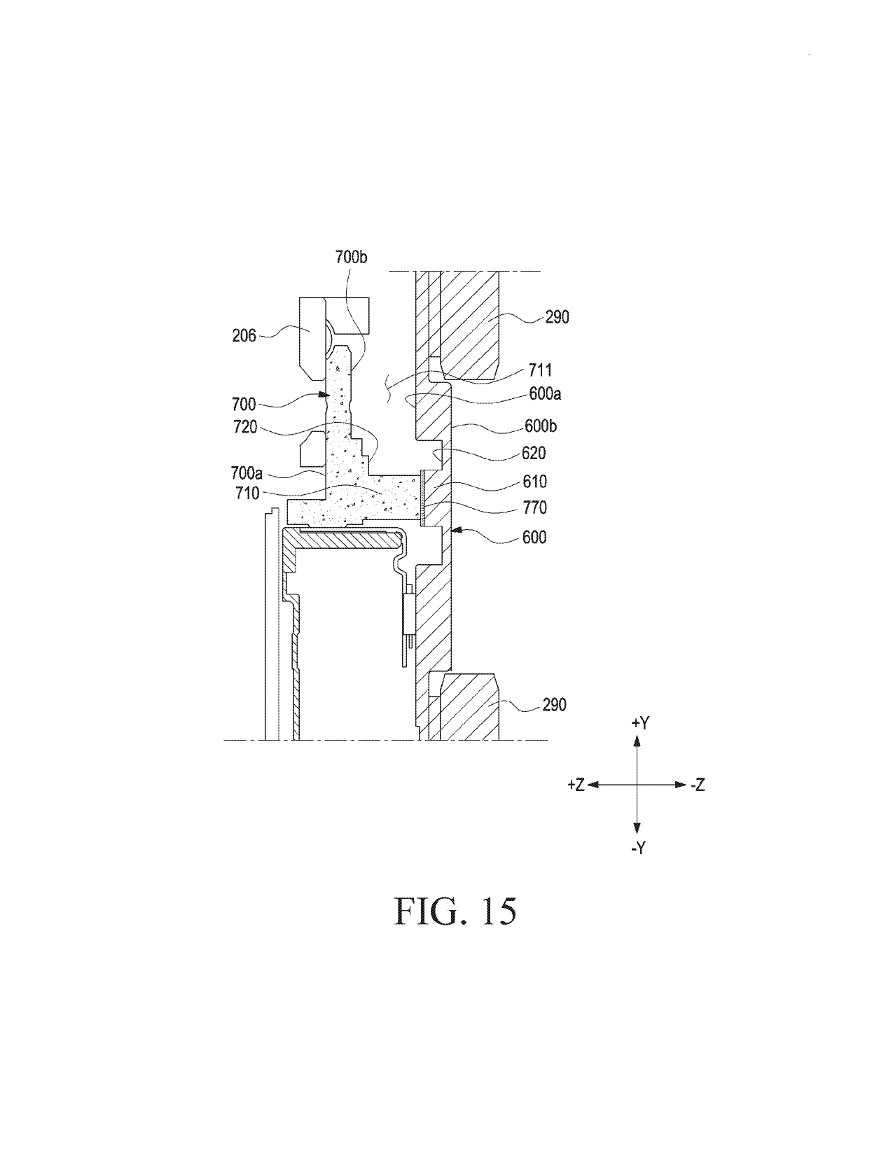

FIG. 15 is a cross-sectional view illustrating a structure in which a camera cover and a camera bracket of an electronic device are coupled according to an embodiment of the disclosure.

FIG. 15 is a cross-sectional view taken along line C-C’ of FIG. 3.

According to an embodiment, the electronic device (e.g., the electronic device 101 of FIG. 4) may include a first housing (e.g., the first housing 210 of FIG. 4), a second housing (e.g., the second housing 220 of FIG. 4), a flexible display (the flexible display 230 of FIG. 4) and a camera structure.

According to an embodiment, at least a portion of the camera structure (e.g., the camera module 206) of the electronic device (e.g., the electronic device 101 of FIG. 4) may be exposed through the rear cover 290 of the electronic device.

The configuration of the camera structure of FIGS. 13, 14, and 15 may be identical in whole or part to the configuration of the camera module 180 of FIG. 1 and the camera module 206 of FIGS. 2 and 3. The embodiments of FIGS. 13 and 14 may be partially combined with the embodiments of FIGS. 1 to 12. For example, among the embodiments of FIGS. 13, 14, and 15, the components of the camera bracket 700, the camera cover 600, and the sheet 770 may be partially combined with the components (e.g., the first protrusion 310 and the loop area 320) of the hinge bracket 300 and the components (e.g., the first portion 410 and the second portion 420) of the hinge cover 240, and the sheet 470 disclosed in the previous embodiments (FIGS. 5 to 12).

According to an embodiment, the camera structure may include a camera module 206. The camera module 206 may include one or more lenses, an image sensor, and/or an image signal processor. According to an embodiment, the camera structure may include at least one camera module (e.g., three camera modules), a camera bracket 700 on which the at least one camera module 206 is disposed, and a camera cover 600 that covers the camera bracket 700 and forms the rear surface of the electronic device together with the rear cover 290.

According to an embodiment, the camera bracket 700 may include a first surface 700a facing in a direction opposite to the camera cover 600 and a second surface 700b facing the camera cover 600. The area in which the camera module 206 is to be disposed may be positioned at the first surface 700a of the camera bracket 700. A portion (e.g., a lens) of the camera module 206 may be positioned in an opening penetrating the camera bracket 700.

According to an embodiment, the camera bracket 700 may include a first protrusion 710 and a loop area 720 disposed to surround a portion of the first protrusion 710. The first protrusion 710 may have a shape protruding toward the camera cover 600 than the loop area 720. The area in which the first protrusion 710 of the camera bracket 700 is disposed may be positioned at the second surface 700b of the camera bracket 700. For example, the first protrusion 710 may protrude in a direction toward the camera cover 600 (e.g., a direction toward the -Z axis). The first protrusion 710 is a portion facing the first portion 410of the camera cover 600, and may be designed to pressurize the first portion 410 of the camera cover 600 when an external impact occurs.

According to an embodiment, the first protrusion 710 may have a circular shape when the second surface 700b of the camera bracket 700 is viewed in the +Z axis direction. For example, when the circular first protrusion 710 collides with the camera cover 600 by impact, it may deform the camera cover 600. The circular first protrusion 710 may be advantageous in deriving the deformed result of the camera cover 600 from several angles. However, the shape of the first protrusion 710 is not limited thereto, and the design may be changed into various shapes for identifying the deformation of the camera cover 600 from various angles.

According to an embodiment, the camera cover 600 is a component for protecting the camera module 206 disposed on the camera bracket 700, and may cover components other than the lens of the camera module 206 so as not to be exposed to the outside. The camera cover 600 may be referred to as a camera protection member or a camera deco.

According to an embodiment, the camera cover 600 may include an inner surface 600a (e.g., a surface facing the +Z axis) facing the camera bracket 700 and an outer surface 600b facing in the opposite direction to the camera bracket 700 (e.g., a surface facing the -Z axis). The camera cover 600 may include a first portion 610 for providing an indicator function and a second portion 620 formed to surround at least a portion of the first portion 610.

According to an embodiment, the first portion 610 of the camera cover 600 may be disposed to face the first protrusion 710 of the camera bracket 700. The first portion 610 of the camera cover 600 may be positioned on the inner surface 600a of the camera cover 600. For example, the first portion 610 may protrude in a direction toward the camera bracket 700 (e.g., a direction toward the +Z axis). The lens of the camera module 206 of the electronic device and the camera cover 600 protecting the lens may be damaged first when an external impact (e.g., dropping) occurs due to the protruding structure. When an external impact occurs, the first protrusion 710 of the camera cover 600 pressurizes the first portion 610 of the camera cover 600, and the pressurized force is transferred to the outer surface 600b of the camera cover 600 (e.g., the outer surface area facing the first portion 610) to deform the camera cover 600. For example, a portion of the outer surface 600b of the camera cover 600 may protrude.

According to an embodiment, the first protrusion 710 of the camera bracket 700 may have a larger strength than the first portion 610 of the camera cover 600. For example, the yield strength of the first protrusion 710 of the camera bracket 700 may be larger than the yield strength of the first portion 610 of the camera cover 600. Since the first protrusion 710 of the camera bracket 700 is relatively stronger than the first portion 610 of the camera cover 600, the force applied from the camera bracket 700 may facilitate the deformation of the camera cover 600.

According to an embodiment, the second portion 620 of the camera cover 600 may have a shape (e.g., a valley shape) dug in the -Z-axis direction compared to other areas of the camera cover 600 adjacent to the second portion 620 and the first portion 610. The second portion 620 of the camera cover 600 may be referred to as a recess, a groove, or an opening. The second portion 620 may have a closed loop shape disposed to completely surround the first portion 610 or an open loop shape disposed to partially surround the first portion 610.

According to an embodiment, one or more predetermined gaps may be formed between the camera bracket 700 and the camera cover 600. For example, the peripheral area of the loop area 720 of the camera bracket 700 and the peripheral area of the second portion 620 of the camera cover 600 may be spaced apart from each other to form a predetermined space or gap 711. For example, a gap 711 may be formed between the second surface 700b of the camera bracket 700 and the inner surface 600a of the camera cover 600 facing the second surface 700b. According to an embodiment, the gap 711 may be a minimum space for forward/rearward movement (e.g., movement in the +Z-axis/-Z-axis direction) between the camera bracket 700 and the camera cover 600 due to an external impact.

According to an embodiment, the camera structure may include at least one camera module (e.g., three camera modules), a camera bracket 700 on which the at least one camera module 206 is disposed, a camera cover 600 that covers the camera bracket 700 and forms the rear surface of the electronic device together with the rear cover 290, and a sheet 770 disposed between the camera bracket 700 and the camera cover 600.

According to an embodiment, in the camera structure, the first protrusion 710 of the camera bracket 700 and the first portion 610 of the camera cover 600 may be disposed in contact with each other.

According to an embodiment, the sheet 770 may be disposed between the first protrusion 710 of the camera bracket 700 and the first portion 610 of the camera cover 600. The sheet 770 may be referred to as a buffer member that provides a buffer function between the hinge bracket 300 and the hinge cover 240. The sheet 770 may include a flexible material. For example, the sheet 770 may include at least one of materials that provide elasticity, such as rubber, polycarbonate (PC), polyethylene terephthalate (PET), or foam. The sheet 770 may be adhered to each of the first protrusion 710 and the first portion 610 to maintain an alignment between the first protrusion 710 of the camera bracket 700 and the first portion 610 of the camera cover 600, regardless of impact. When an impact occurs, the sheet 770 may be flexibly deformed so that the force generated by the first protrusion 710 may be sufficiently transferred to the first portion 610.

According to an embodiment, the sheet 770 may have a size (e.g., a diameter) corresponding to the first portion 610 of the camera cover 600 and/or the first protrusion 710 of the camera bracket 700. For example, when the first portion 610 of the camera cover 600 has a circular shape, the sheet 770 may be a piece of circular contact paper. For example, the size (e.g., diameter) of the sheet 770 may be less than or equal to the size (e.g., diameter) of the first portion 610 of the camera cover 600.

A foldable electronic device may have a foldable flexible display disposed therein and may include a plurality of housings for supporting the flexible display. Various components may be disposed and/or mounted in each of the plurality of housings of the foldable electronic device. The foldable electronic device may include a hinge structure for easily folding or unfolding the flexible display.

When an external impact such as a drop occurs in the foldable electronic device, the exterior of the device may be deformed as the hinge structure disposed at the edge of the electronic device and/or the camera structure partially protruding collides with the floor (e.g., the ground). However, as it is difficult to distinguish the consumer's intended dent shape from the dent shape caused by the drop impact from the appearance of the electronic device, a method to distinguish them may be necessary.

According to an embodiment of the disclosure, it is possible to easily identify whether damage is caused by external impact by forming a structure for an indicator for identifying an external impact such as a drop, in the hinge structure and/or the camera structure in the electronic device.

The disclosure is not limited to the foregoing embodiments but various modifications or changes may rather be made thereto without departing from the spirit and scope of the disclosure.

According to an embodiment of the disclosure, in a hinge structure of a foldable electronic device, a structure in which a protrusion shape of a hinge bracket and a shape of a hinge cover corresponding to the protrusion shape are disposed to face each other may be provided. When an external impact occurs, the protrusion shape of the hinge bracket may pressurize the hinge cover to partially change the shape, and consumers and/or repair persons may easily identify whether the damage is caused by impact from dropping.

According to an embodiment of the disclosure, in a camera structure of an electronic device, a structure in which a protrusion shape of a camera bracket and a shape of a camera cover corresponding to the protrusion shape are disposed to face each other may be provided. When an external impact occurs, the protrusion shape of the camera bracket may pressurize the camera cover to partially change the shape, and consumers and/or repair persons may easily identify whether the damage is caused by impact from dropping.

Effects obtainable from the disclosure are not limited to the above-mentioned effects, and other effects not mentioned may be apparent to one of ordinary skill in the art from the following description.

An electronic device (e.g., the electronic device 101 of FIGS. 1 to 4) according to an embodiment of the disclosure may comprise a first housing 210, a second housing 220, a flexible display 230 including an area corresponding to the first housing and an area corresponding to the second housing, a hinge assembly 202 at least partially disposed between the first housing and the second housing, and rotatably connecting the first housing and the second housing, a hinge bracket 300 accommodating the hinge assembly and including a first protrusion 310 formed to protrude in a direction opposite to the flexible display, a hinge cover 240 formed to cover the hinge bracket, and including a first portion 410 facing the first protrusion and a second portion 420 formed to surround at least a portion of the first portion, and a sheet 470 disposed between the first protrusion of the hinge bracket and the first portion of the hinge cover.

According to an embodiment, a yield strength of the first protrusion of the hinge bracket may be larger than a yield strength of the first portion of the hinge cover.

According to an embodiment, a gap may be formed between the hinge bracket and the second portion of the hinge cover.

According to an embodiment, when an external force of a designated magnitude or more is provided from an outside of the hinge cover, the first protrusion of the hinge bracket may pressurize the first portion of the hinge cover so that at least a portion of the hinge cover may be deformed toward a direction opposite to the hinge bracket.

According to an embodiment, a size of an outer surface of the first protrusion of the hinge bracket may be smaller than or equal to a size of an outer surface of the first portion of the hinge cover.

According to an embodiment, a size of an outer surface of the sheet may be smaller than or equal to a size of an outer surface of the first protrusion.

According to an embodiment, an elastic force of the sheet may be larger than an elastic force of the hinge bracket or the hinge cover.

According to an embodiment, the first protrusion may be disposed adjacent to an upper edge or a lower edge of the hinge cover.

According to an embodiment, when viewed in a direction perpendicular to an outer surface of the hinge cover, the first protrusion of the hinge bracket may be disposed at or adjacent to a center of the hinge cover with respect to an upper edge of the hinge cover.

According to an embodiment, the first portion of the hinge cover may protrude further than the second portion in a direction opposite to the hinge bracket.

According to an embodiment, the first protrusion of the hinge bracket may have a circular shape, and the first portion of the hinge cover may have a shape corresponding to the first protrusion.

According to an embodiment, the hinge bracket may include a loop area 320 disposed to surround the first protrusion 310, and the loop area may be disposed to face, and be spaced apart from, at least a portion of the second portion of the hinge bracket.

According to an embodiment, an outer surface of the first protrusion of the hinge bracket may form an inclined surface to have a designated slope with respect to the loop area.

According to an embodiment, the hinge cover may include a deformable portion 430. The deformable portion may include the first portion facing the hinge bracket, the second portion, and a recessed area 430a opposite to the first and second portions.

According to an embodiment, the electronic device may further comprise a cover member 510 facing the recessed area and disposed such that the deformable portion of the hinge cover is not exposed to an outside.

According to an embodiment, the electronic device may comprise an adhesive member 520 disposed on an edge of the cover member and bonding the cover member to the deformable portion of the hinge cover.

According to an embodiment, the electronic device may comprise pressure sensitive member 530 disposed between the deformable portion of the hinge cover and the cover member.

A hinge structure of an electronic device (e.g., the electronic device 101 of FIGS. 1 to 4) according to an embodiment of the disclosure may comprise a hinge assembly 202, a hinge bracket 300 accommodating the hinge assembly and including a first protrusion 310 formed to protrude in a first direction and a loop area 320 formed to surround the first protrusion, a hinge cover 240 including a first portion 410 protruding in a second direction opposite to the first direction to face the first protrusion and a second portion 420 formed to surround at least a portion of the first portion, and a sheet 470 disposed between the first protrusion of the hinge bracket and the first portion of the hinge cover.

According to an embodiment, a yield strength of the first protrusion of the hinge bracket may be larger than a yield strength of the first portion of the hinge cover.

According to an embodiment, the first protrusion may be disposed adjacent to an upper edge or a lower edge of the hinge bracket.

An electronic device (e.g., the electronic device 101 of FIGS. 1 to 4) according to an embodiment of the disclosure may comprise a first housing 210, a second housing 220, a flexible display 230 disposed to include an area corresponding to the first housing and an area corresponding to the second housing, an electric component disposed in the electronic device, a bracket 300; 700 accommodating the electric component and including a first protrusion 310; 710 formed to protrude in a direction opposite to the flexible display and a loop area 320; 720 disposed to surround at least a portion of the first protrusion, a cover 240; 600 formed to cover a portion of the bracket and including a first portion 410; 610 facing the first protrusion and a second portion 420; 620 formed to surround at least a portion of the first portion, and a sheet 470; 770 disposed between the first protrusion of the bracket and the first portion of the cover.

According to an embodiment, a yield strength of the first protrusion of the bracket may be larger than a yield strength of the first portion of the cover.

What is claimed is:

1. An electronic device , comprising:
a first housing ;
a second housing ;
a flexible display including an area corresponding to the first housing and an area corresponding to the second housing;
a hinge assembly at least partially disposed between the first housing and the second housing, and rotatably connecting the first housing and the second housing;
a hinge bracket accommodating the hinge assembly and including a first protrusion formed to protrude in a direction opposite to the flexible display; and
a hinge cover formed to cover the hinge bracket, and including a first portion facing the first protrusion and a second portion formed to surround at least a portion of the first portion.

2. The electronic device of claim 1, wherein a yield strength of the first protrusion of the hinge bracket is larger than a yield strength of the first portion of the hinge cover.

3. The electronic device of claim 1, wherein a gap is formed between the hinge bracket and the second portion of the hinge cover.

4. The electronic device of claim 1, wherein, when an external force of a designated magnitude or more is provided from an outside of the hinge cover, the first protrusion of the hinge bracket is configured to pressurize the first portion of the hinge cover so that at least a portion of the hinge cover is deformed toward a direction opposite to the hinge bracket.

5. The electronic device of claim 1, wherein a size of an outer surface of the first protrusion of the hinge bracket is smaller than or equal to a size of an outer surface of the first portion of the hinge cover.

6. The electronic device of claim 1, further comprising a sheet (470) disposed between the first protrusion of the hinge bracket and the first portion of the hinge cover,
wherein a size of an outer surface of the sheet is smaller than or equal to a size of an outer surface of the first protrusion, and
wherein an elastic force of the sheet is larger than an elastic force of the hinge bracket or the hinge cover.

7. The electronic device of claim 1, wherein the first protrusion is disposed adjacent to an upper edge or a lower edge of the hinge cover.

8. The electronic device of claim 1, wherein, when viewed in a direction perpendicular to an outer surface of the hinge cover, the first protrusion of the hinge bracket is disposed at or adjacent to a center of the hinge cover with respect to an upper edge of the hinge cover.

9. The electronic device of claim 1, wherein the first portion of the hinge cover protrudes further than the second portion in a direction opposite to the hinge bracket.

10. The electronic device of claim 1, wherein the hinge bracket includes a loop area disposed to surround the first protrusion), and wherein the loop area is disposed to face and be spaced apart from at least a portion of the second portion of the hinge bracket.

11. The electronic device of claim 10, wherein an outer surface of the first protrusion of the hinge bracket forms an inclined surface to have a designated slope with respect to the loop area.

12. The electronic device of claim 1, wherein the hinge cover includes a deformable portion, wherein the deformable portion includes the first portion facing the hinge bracket, the second portion, and a recessed area opposite to the first and second portions, and
wherein the electronic device further comprises a cover member facing the recessed area and disposed so that the deformable portion of the hinge cover is not exposed to an outside.

13. The electronic device of claim 12, further comprising an adhesive member disposed on an edge of the cover member and bonding the cover member to the deformable portion of the hinge cover.

14. The electronic device of claim 13, further comprising a pressure sensitive member disposed between the deformable portion of the hinge cover and the cover member.

15. The electronic device of claim 1, further comprising:
a camera module disposed in the electronic device;
a camera bracket having the camera module disposed therein, and including a second protrusion formed to protrude in a direction opposite to the flexible display and a loop area disposed to surround at least a portion of the second protrusion; and
a camera cover formed to cover a portion of the camera bracket and including a third portion facing the second protrusion and a fourth portion formed to surround at least a portion of the third portion.
